(19) United States
(12) Patent Application Publication
(10) Pub. No.: US 2002/0038264 A1
(43) Pub. Date: Mar. 28, 2002

(54) Computer implemented purchase support system that provides item and store search, anonymous reservation, and goods forwarding service

(75) Inventor: Yoshiaki Ishikawa, Tokyo (JP)

Correspondence Address: PARKHURST & WENDEL, L.L.P., Suite 210, 1421 Prince Street, Alexandria, VA, 22314-2805, US

(73) Assignee: MATSUSHITA ELECTRIC INDUSTRIAL CO., LTD

(21) Appl. No.: 09/956,794

(22) Filed: Sep. 21, 2001

(30) Foreign Application Priority Data
Sep. 22, 2000 (JP) 2000-288381

(51) Int. Cl. G06F 17/60

(52) U.S. Cl. 705/27; 705/6

(57) ABSTRACT

An item and store retrieval method and system permits a user to input user key words and provides the user with information on at least one item that match(s) the user key words and, for each provided item, information on at least one store keeping a stock of the provided item. The system comprises a plurality of store apparatuses provided in respective stores, a center apparatus communicating with the store apparatuses, and a user terminal used by the user and capable of communicating with the center apparatus. The items may be articles or services. An anonymous reservation scheme is also disclosed. This permits a user to have a desired item reserved by a store without letting the store know any private information.

### BACKGROUND OF THE INVENTION

1. Field of the Invention

The invention relates to a method and system for providing various facilities to a potential customer when he or she purchases an article or service (hereinafter, referred to en bloc as “items”).

2. Description of the Prior Art

It is sometimes the case that a consumer has something he or she wants in mind but doesn't know what it is called or can not remember its name. For example, in purchasing a book, one can easily hit on some terms and other words concerning a desired book but it is difficult to select a book that best satisfies his or her needs on the basis of such key words. Further, even if the consumer knows an item to buy, it is also difficult to know the store that keeps the stock of the desired item and is nearest from where he or she is.

What is needed is an item and store retrieval system which is available wherever the consumer may be and which, in response to the query words given by the consumer, presents information on items that best match the query words and stores that keep the stock of the retrieved items.

If the item the consumer is going to buy is limited in number or in a excellent demand, then it may happen that even if the consumer makes sure in advance that a certain store keeps the stock of his or her desired item, the item is sold out when he or she gets to the store. A typical measure taken to prevent such a situation is to have the item reserved by disclosing consumer's private data such as the name, the residential address, the phone number, etc. and, if occasion demands, making a deposit. However, if the reserved item has been selected without seeing a real item only by using any information source such as any retrieval system, an advertisement or the like, then when the consumer who has made the reservation examines a real item at the store where he or she is going to buy the reserved item, he or she may find that the reserved item is different from what he or she imaged, changing his or her mind to desire to cancel the reservation. If the item reservation has been made without a deposit, then since canceling the reservation makes the dealer unpleasant, the canceling process is stressful to the consumer. However, since the dealer knows information necessary for contacting the customer, if the consumer has decided not to buy the reserved item, then he or she cannot help notifying his or her intention to the dealer. Further, consumer's input private data is transmitted through one or more networks and, accordingly, may be intercepted or flow out. This may lead to an invasion of consumer's privacy.

From this point of view, what is needed is a purchase support system which enables a consumer or potential customer to make an advance order of a desired item without disclosing his or her private information such as the name, the residential address, the telephone number and the like.

Depending on the location of a consumer, it may be the case that any of stores near the consumer does not deal in his or her desired item or is out of the item though dealing in it. In such a case, it is very convenient for the consumer to have his or her desired item forwarded to a nearby store.

What is needed is a purchase support system that provides an article-forwarding service.

### SUMMARY OF THE INVENTION

According to an aspect of the invention, there is provided an item and store retrieval method and system for permitting a user to input user key words and for providing the user with information on at least one item that match(s) the user key words and, for each provided item, information on at least one store keeping a stock of the provided item. The system comprises a plurality of store apparatuses provided in respective stores, a center apparatus capable of communicating with the store apparatuses, and a user terminal used by the user and capable of communicating with the center apparatus. The items may be articles or services. The center apparatus generates a set of unique item codes collected from all stores involved; assigns each item code item key words suitable to an item identified by the item code to generate a set of relations, each relation associating one of the unique item codes with item key words assigned to the unique item code; collects, from each store apparatus, a list of item codes of items kept in stock by the store having the store apparatus; retrieves item codes from the set of relations by using the user key words; obtains store codes associated with each of the retrieved item codes by using all of the lists of item codes; and provides the user terminal with at least a pert of the retrieved item codes and further providing, for each of at least a pert of said retrieved item codes, at least a part of said obtained store codes.

According to another aspect of the invention, there is provided an anonymous reservation method and system for permitting a user to have a desired item reserved by a store without letting the store know any private information. The hardware configuration may be the same as the above-outlined item and store retrieval system. In the system, in response to a request from the user, the center apparatus presents a plurality of item identifiers of items available from the respective stores and a store identifier of a store that keeps a stock of each of the available items. The center apparatus prompts the user to make a reservation for one of the retrieved item codes. In response to a detection of a user's intention of making a reservation, the user terminal sends a reservation request, a selected item code selected by the user and a store code of a store that keeps a stock of said selected item code to the center apparatus. In response to a reception of the reservation request, the center apparatus generates a unique reservation code for said reservation, sending the reservation code and the selected item code to the store apparatus identified by the store code. In response to a reception of the reservation code, the store apparatus identified by the store code stores a record including the reservation code, the selected item code and a valid term associated with the selected item code, and sends the valid term to the center apparatus. In response to a reception of the valid term, the center apparatus sends the reservation code and the valid term to the user terminal. In response to an input of a reservation code presented by a customer, the store apparatus deletes the record if the presented reservation code is identical to the reservation code of the stored reservation record and valid considering from the valid term of the stored reservation record. This completes the processing of a reservation.

### BRIEF DESCRIPTION OF THE DRAWING

Further objects and advantages of the present invention will be apparent from the following description of the preferred embodiments of the invention as illustrated in the accompanying drawing, in which:

FIG. 1A is a diagram showing an overall configuration of a purchase support system of the invention;

FIG. 1B is a functional block diagram showing the architecture commonly required for the user terminals 30 shown in FIG. 1A;

FIG. 2 is a flowchart showing a rough procedure a user follows to purchase an item by using a purchase support system of the invention;

FIGS. 3A through 3D are diagrams showing an exemplary configuration of basic data files stored in the mass storage 13 and used in the store information management system 10;

FIG. 4 is a diagram showing exemplary center data files 200, 210, 220 and 230 stored in the mass storage 25 of center system 20 and a way of generating the center data files from the store data files of FIGS. 3;

FIGS. 5A and 5B are flowcharts showing the operations to update the item-to-store table 220 in response to a sales and a buying-in, respectively, of an item of an item code ICDj;

FIG. 6 is a flowchart showing an exemplary operation executed to effect the stock-keeping store retrieval function used in step 41 of FIG. 2;

FIG. 7 is a diagram showing an exemplary query input page displayed in step 161 of FIG. 6;

FIG. 8 is a diagram showing an exemplary search result display page displayed in response to a clicking of the “search” button of FIG. 7;

FIG. 9 is a diagram showing an exemplary detailed store information display page displayed in response to a clicking of a store name on the search result display page of FIG. 8;

FIG. 10 is a diagram showing an exemplary related item search result display page displayed in response to a clicking of the “CLICK HERE” button 199 of FIG. 8;

FIG. 11 is a flowchart showing an exemplary related item retrieval operation initiated by clicking the button 199 of FIG. 8;

FIG. 12 is a diagram showing an exemplary data file maintained by each store system 10.i for use in the calculation of the degree of the congestion as shown in FIGS. 8 and 10;

FIG. 13 is a diagram showing an exemplary similar key word search result display page displayed in response to a clicking of the “SIMILAR KEY WORDS” button of FIG. 7;

FIG. 14 is a diagram showing the data structure and a generating method of an item-to-dealing store table used instead of the item-to-store table 220;

FIG. 15 is a diagram showing an exemplary reservation request page displayed in response to a click of any reservation buttons in the “click here to reserve” column 196;

FIG. 16 is a flow diagram showing the flows of data and operation in an anonymous reservation in accordance with the present invention;

FIG. 17 is a diagram showing an example of a provisional reservation certificate issued in response to a booking of a provisional reservation;

FIG. 18 is a diagram showing an example of a reservation history display provided in response to a predetermined operation by user;

FIG. 19 is a diagram showing an example of an article-forwarding reservation entry page;

FIG. 20 is a flow diagram showing the flows of data and operation in an article-forwarding reservation in accordance with the present invention;

FIG. 21 is a diagram showing an example of a reservation history display that is also available to the article-forwarding reservation;

FIG. 22 is a flowchart showing an exemplary purchase operation executed in step 48 of FIG. 2;

FIG. 23 is a diagram showing an exemplary arrangement of a reservation record;

FIG. 24 is a diagram showing a partial operation flow that, when inserted in the path between steps 141 and 143 of FIG. 5A, adds a selling-out prevention function; and

FIG. 25 is a diagram showing an exemplary reservation request (entry) page displayed in response to a click of any reservation buttons associated with a store that offers some form of benefits to customers who have made a reservation and comes to the store within a set time limit.

Throughout the drawing, the same elements when shown in more than one figure are designated by the same reference numerals.

### DETAILED DESCRIPTION OF THE PREFERRED EMBODIMENTS

### Hardware Configuration

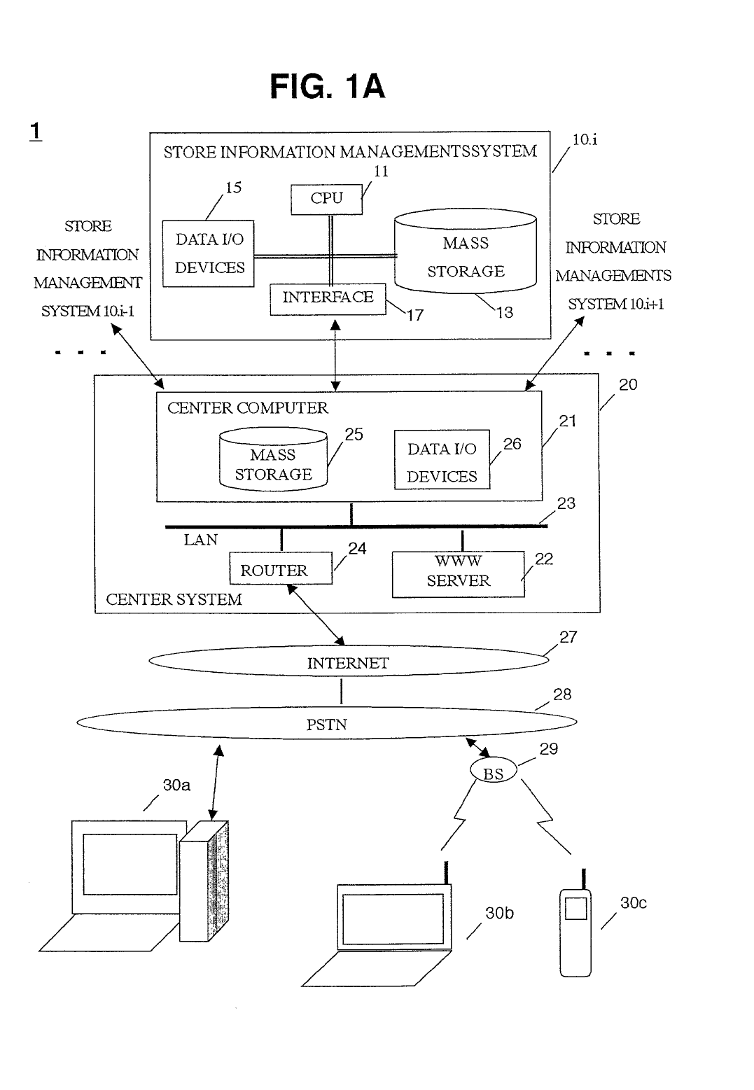

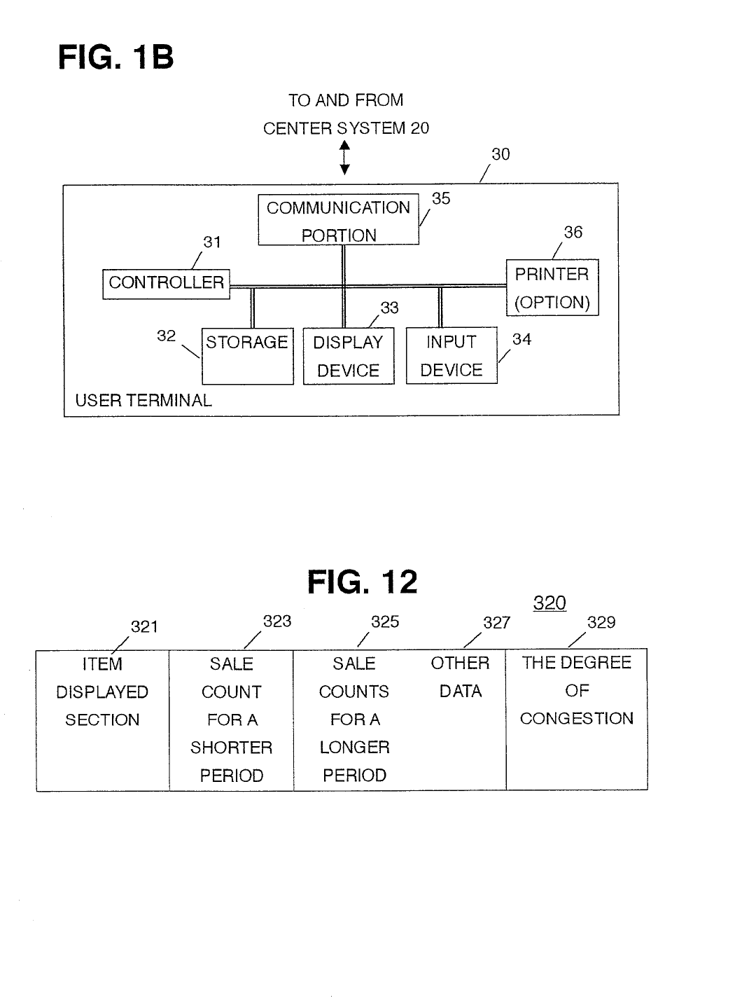

FIG. 1A shows an overall configuration of a typical purchase support system 1 of the invention. In FIG. 1A, the purchase support system 1 typically comprises a multiplicity of store information management systems {10.i | i=1, 2, . . . , N} provided in respective stores (not shown) participating in a purchase support network of the system 1; a center system 20 that serves as a hub of the purchase support system 1; and a multiplicity of user terminals such as 30a, 30b and 30c (denoted en bloc by reference numeral “30”). The connection between the center system 20 and each store information management system 10.i may be achieved by using either a private telephone line or an ordinary telephone line. The user terminals 30 communicate with the center system 20 via the Internet 27. The user terminals 30 can get access to the Internet 27, for example, through a PSTN (public switched telephone network) 28 or through a radio or mobile telephone base station (denoted as “BS”) 29 and the PSTN 28.

The N participant stores may be comprised of independent stores, chain stores under the control of a managing company, main and branch stores of a large dealer, or any combination of them. Also, the participant stores may include one or more virtual stores run on the Internet. Though the actual configurations of the store information management systems 10.1 through 10.N may vary store by store, each store system 10.i may be any suitable computer, which preferably comprises a CPU (central processing unit) 11 for controlling the overall system 10.i; a mass storage 13 for storing various programs and data, which are detailed later; data input and output (I/O) devices 15 such as a display device, a keyboard and the like; and an interface 17 for communicating with the center system 20.

A store information management system 10.i may be implemented as a part of a POS (point of sales) system provided in a relatively small store. Alternatively, a store system 10.i may be implemented as a computer system connected with a plurality of POS systems provided in a relatively large store. Also, it is not necessary but preferable that more store information management systems 10 include a WWW (World Wide Web) server and retain information on respective stores themselves and items they deal with in the form of web page data. Doing this enable the center system 20 to utilize such information without collecting and storing the information in the center system.

The center system 20 is a computer-based system and preferably includes a WWW server so as to offer a purchase support service as WWW pages. Specifically, the center system 20 comprises a center computer 21 for performing most of necessary jobs as center system 20; a WWW server 22 for providing an interface between the center computer 21 and each of the user terminal 30; a LAN (local area network) 23 through which the center computer 21 and the WWW server 22 communicate with each other; and a router 24 for providing an interface between the WWW server 22 and the Internet 27. The center computer 21 includes a mass storage 25 for storing various programs and data, which are detailed later; and data input and output (I/O) devices 26 such as a display device, a keyboard and the like as well as a communication interface (not shown) for communicating with the store information management systems 10 and a LAN interface (not shown).

Though each of the mass storages 13 and 25 are shown as if it was a single hard disc, the mass storages 13 and 25 may comprised of a plurality of mass storage device, and may even include different types of mass storage devices such as a hard disc and an optical disc of a certain kind.

FIG. 1B is a functional block diagram showing an architecture commonly required for the user terminals 30 shown in FIG. 1A. Each user terminal 30 may be any suitable device capable of both communicating data with the center system 20 and executing a terminal program (not shown) for giving an interface between the user and the center system 20. From this viewpoint, the user terminal 30 preferably comprises a controller 3 1(including not-shown CPU, ROM (read only memory) and RAM (random access memory)), a storage device 32, a display device 33 and an input device 34 such a keyboard or key pad, which constitute a computer. The user terminal 30 further comprises a communication portion 35 for communicating with the center system 20. The communication portion 35 may be either a modem (modulator and demodulator) accessible to the PSTN 27 or a radio transmitter/receiver accessible to the radio telephone base station 29. The user terminal 30 may be optionally provided with a printer 36 (the usage of which is described later).

As long as these conditions are satisfied, the user terminal 30 may be any of desktop computer 30a with a modem, portable terminal 30b (e.g., a lap-top computer, hand-held or palm-size computer and the like) with a radio or cellular telephone network capability, and mobile telephone 30c capable of browsing the WWW pages, The storage device 32 is preferably a hard disc if the user terminal 30 is a desktop or portable computer 30a or 30b and a nonvolatile semiconductor memory device if the user terminal 30 is a mobile telephone 30c.

### General View of Functions

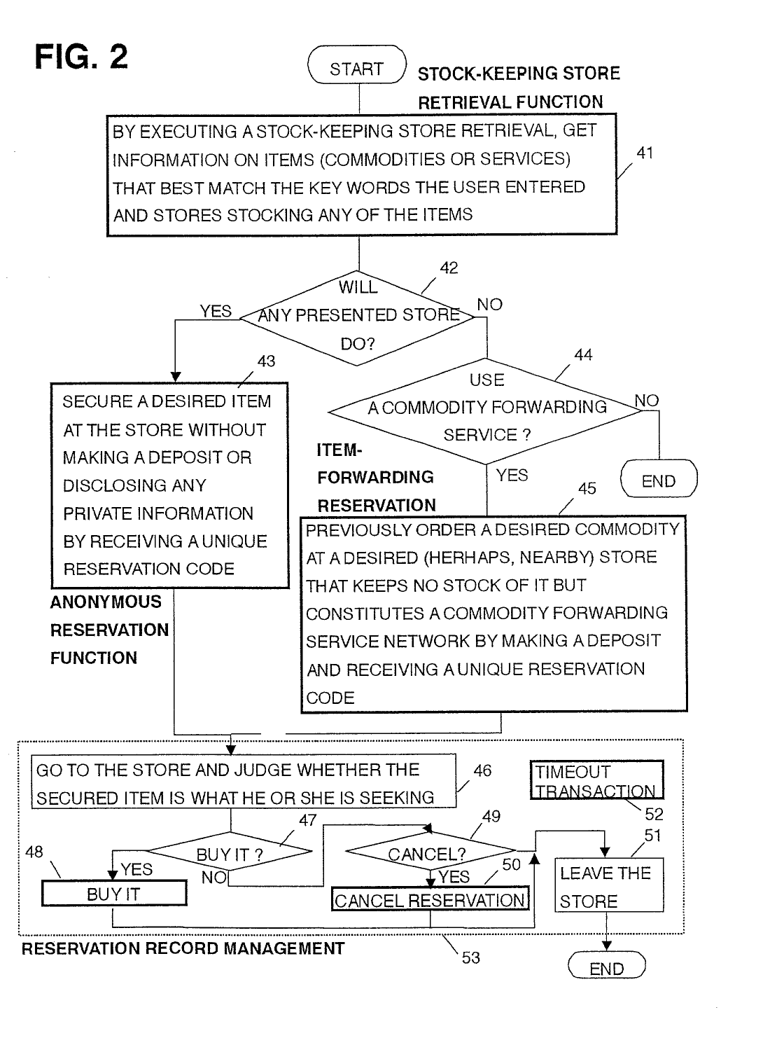

FIG. 2 is a flowchart showing a rough procedure a user follows to purchase an item by using a purchase support system 1 of the invention. In FIG. 2, the blocks drawn with thick lines indicate user's respective actions realized with the help of programs or functions (indicated by bold letter notations along respective blocks) of an illustrative embodiment of the invention.

According to an aspect of the invention, by entering key words relating to an item (i.e., an article or service) the user is seeking, he or she can get information on not only items that best match the entered key words but also one or more stores that keep each of the matched items through a Stock-keeping Store Retrieval Function or Program of the system 1 as shown in step 41. Then, the user makes a decision on whether he or she should buy any presented or retrieved item from any presented stock-keeping store in step 42. If so, then the user proceeds to step 43.

According to another aspect of the invention, the user can secure a desired item at a presented store without making a deposit or disclosing any private information by receiving a unique reservation code through an Anonymous Reservation Function of system 1 as shown in step 43. After step 43, the user proceeds to a purchase step 53, i.e., a step 46.

If the answer is NO in the decision step 42, then the user proceeds to another decision step 44, where he or she makes another decision on whether he or she uses an article forwarding service. If not, then the user stops using the purchase support system 1. If the answer is YES in the decision step 44 (which is the case when the user has found a desired one in the presented items but any of the presented stock-keeping stores is not so near by as to urge him or her to buy from it), then the user proceeds to step 45.

According to further aspect of the invention, the user can previously order a desired article at a desired (perhaps, nearby) store that keeps no stock of it but constitutes an article forwarding service network by making a deposit and receiving a unique reservation code through an Article-forwarding Reservation Function or Program as shown in step 45. After step 45, the user proceeds to a purchase step 53, i.e., a step 46.

Upon receiving an anonymous or article-forwarding reservation request, the system 1 books a reservation record for the reservation request and manages the reservation record with Reservation Record Management Functions as shown in step 53.

In step 46, the user goes to the store and judges whether the secured or reserved item is just what he or she is seeking. And, the user makes a decision on whether he or she should buy it or not in step 47. If so, he or she buys it in step 48. Otherwise, the user makes another decision, in step 49, on whether he or she cancels the reservation or simply leaves the store without canceling it.

According to the present invention, the user can do without buying the reserved item without feeling much stress by notifying his or her intention of cancel to the store in step 50 or simply leaving the store in step 5 1. It is especially true to an anonymous reservation case.

In order to mitigate the loss caused by such a cancellation, a timeout transaction 52 is executed.

As seen from the foregoing, the above-mentioned reservation record management functions includes an article-forwarding transaction (in case of the article-forwarding reservation); a sales transaction (48); a cancel transaction (47); and a timeout transaction 52.

### Exemplary Data Configuration

In order to realize the above-mentioned functions, a system integrator preferably prepares necessary data in advance.

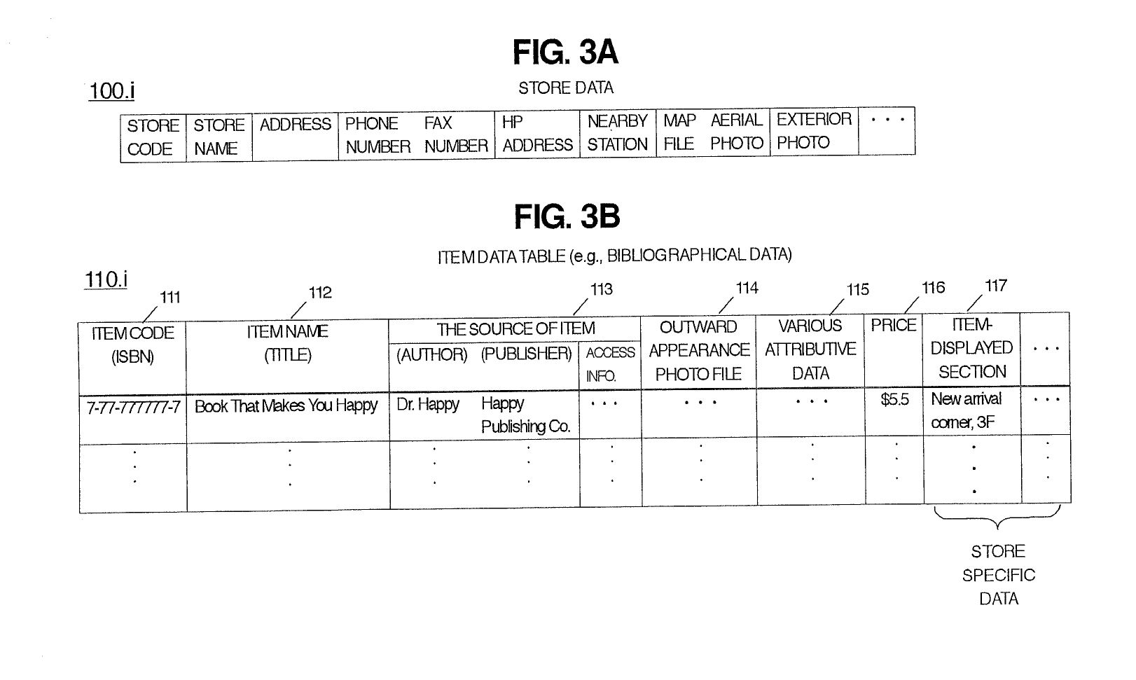

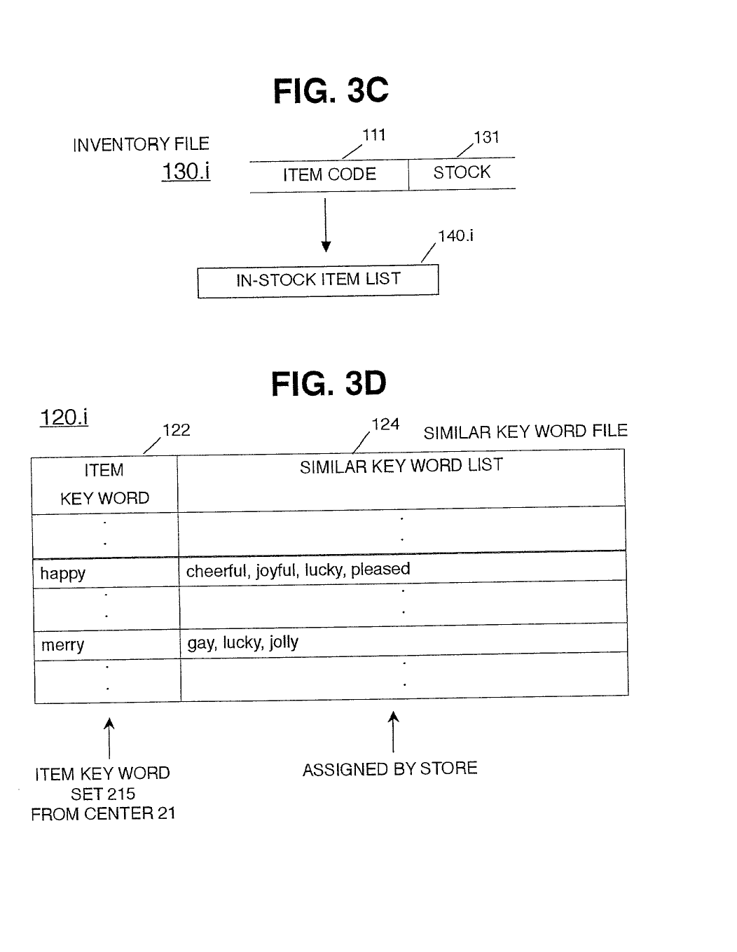

FIGS. 3A through 3D are diagrams showing an exemplary configuration of basic data files stored in the mass storage 13 and used in the store information management system 10.i. The mass storage 13 stores, for example, a store data file 100.i shown in FIG. 3A; an item data table or file 110.i shown in FIG. 3B; an inventory file 130.i and an in-stock item list 140.i shown in FIG. 3C; and a similar key word file 120.i shown in FIG. 3D.

In FIG. 3A, the store data file 100.i contains information on the store, including a store code by which the store is identified; a store mane; an address, a phone number field, a facsimile number field, a home page (HP) address field (if any), a nearby station field, a map file location, an aerial photo file location, an exterior photo file location. It is noted that each field may contain a plurality of values. If the information management system 10 is provided with a WWW server as already mentioned, then each file location preferably contains the URL of a relevant web page. Otherwise, each file location preferably contains the location or path name of the file. Needless to say, the mass storage 13 stores actual data for each of such file location fields at the location specified by the value of the location field.

It is noted that if the store information management system 10.i is not provided with a WWW server, a predetermined code to the effect is preferably entered in the HP address field. This enables the center system 20 to select, for each store, one of two different operation modes: i.e., a web server mode and a non-web server mode, depending on the value of the HP address field.

In FIG. 3B, the item data table 110.i contains the information records for all of the items (i.e., the articles and the services) the store is dealing with. Each record of the table 110.i comprises, for example, an item code field 111; an item name field 112; source-of-item fields 113 which contains information on the source of item (i.e., the manufacturer or the publisher in case of books); an outward appearance photo file location field 114 which contains a location of file containing a photograph of an outward appearance of the store; various attributive data fields 115; a price field 116; an item displayed section field 117 which contains a section or corner where the item is displayed or exhibited in the store; and other fields. The source-of-item fields 113 may include fields for any piece of information concerning the source of the item identified by the item code 111. In this specific example (i.e., a book and book store retrieval system), the source-of-item fields 113 may include an author field, a publisher field, access information fields and the like. The access information fields include various kinds of addresses such as a location address, a phone number, an electronic mail address, etc.

Though most data in the item data table 110 records are specific to the item identified by the item code 111, the item data table 110 records may include data depending on not only the item but also the store. The item displayed section 117 is among such data. The usage of item displayed section 117 will be detailed later.

In the table 110.i of FIG. 3B, there is shown data of an exemplary item data record. In this specific example, it is assumed that the N stores are bookstores. Though we use the case of bookstores throughout the specification, this is only for the purpose of the description of the invention. However, it should be noted that the invention is applicable to a combination of plural kinds of items, not to mention, to any kinds of item. In case of a book purchase support system, the various attributive data fields 115 will contain various bibliographic data of the book.

In FIG. 3C, the inventory file 130.i contains the inventory records for all of the items the store is dealing with. Each record comprises the above-mentioned item code field 111 and an inventory field 131 for containing the inventory of the item or the number of items actually being kept in the store. It is noted that the inventory file 130.i may be incorporated in the item data table 110.i by simply adding the inventory field 131 to the table 110.i.

Also, as shown in FIG. 3C, the CPU 11 generates an in-stock item list 140.i from the inventory file 130.i and sends the list 140.i to the center computer 21. The in-stock item list 140.i is a list of items that are actually stocked in the store.

Prior to the practical operation, CPU 11.i of each store i sends the above-described store data file 100.i, item data table 110.i and in-stock item list 140.i to the center computer 21.

The similar key word file 120.i of FIG. 3D will be detailed later.

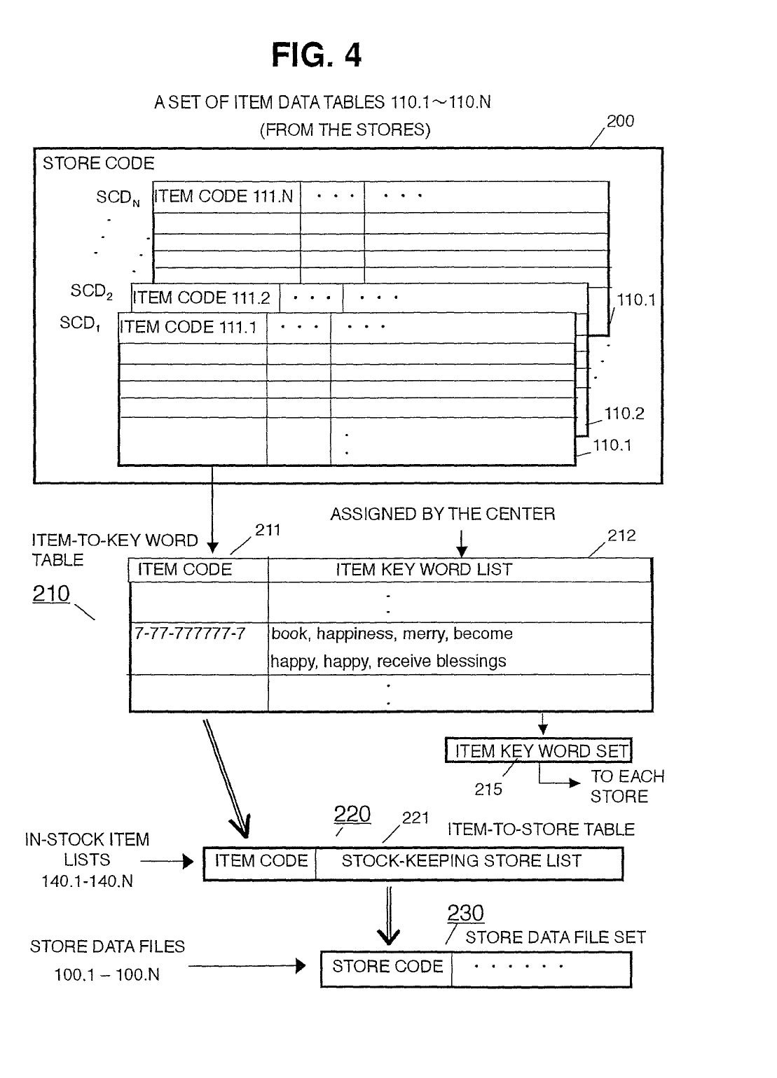

FIG. 4 is a diagram showing exemplary center data files 200, 210, 215, 220 and 230 stored in the mass storage 25 of center system 20 and exemplary ways of generating these center data files from the above-described store data files of FIGS. 3. In FIG. 4, each of the single line arrows indicates that the data from which the arrow is projecting is used for the generation of the data at the arrowhead. Each of the double line arrows indicates the reference from one to the other.

In the system preparation stage, the center computer 21 first collects and stores in the mass storage 25, the store data files 100.1 through 100.N, the item data files 110.1 through 110.N, and the in-stock item lists 140.1 through 140.N from all of the N store information management systems 10.1 through 10.N.

In this case, the computer 21 creates a set 200 of item data tables 110.1 through 110.N by storing these tables in an identical directory or folder associating the tables 110.1 through 110.N with respective store codes SCD₁, SCD₂, . . . , SCD_{N}. Note that a notation SCDᵢ is a variable representative of the store code of store i (i=1, 2, . . . , N).

Then, the center computer 21 searches all the item code fields 111 of the item data tables 110.1 through 110.N and collects all the unique item codes and makes a set of unique item codes such that each item code of the set is different from any other item codes of the set. Further, the computer 21 generates an item-to-key word table 210 such that the key (first in the example of FIG. 4) fields 211 of the table 210 contains the respective unique item codes of the set and the second field 212 of each record of the table 210 contains a list of item key words. That is, an appropriate person in charge in the center assigns appropriate key words or phrases to each of the items. There is shown an exemplary record in the item-to-key word table 210. Specifically, the exemplary record contains an item code “7-77-777777-7” in the item code field 211 and an item key words “book”, “happiness”, “merry”, “become happy”, “happy”, and “receive blessings” in the item key word list field 212. Thus obtained item-to-key word table 210 is used for retrieving one or more items that best match the key words given by the user as detailed later.

The center computer 21 then searches all of the item key word list fields 212 of the table 210 and collects all the unique key words and phrases, which constitute an item key word set 215. The computer 21 sends the item key word set 215 to each 10.i of the store information management systems.

Turning now to FIG. 3D, each store information management system 10.i responsively assigns, to each item key word of the received item key word set 215, desired similar key words. Doing this, the system 10.i creates a similar key word file 120.i. Each of the records of the similar key word file 120.i is comprised of an item key word field 122 that contains one item key word of the item key word set 215 and a similar key word list field 124 that contains the assigned similar key words. In FIG. 3D, there are two exemplary records for key words “happy” and “merry”.

Returning to FIG. 4, the center computer generates an item-to-store table 220 by making a file containing the records each of which further containing a field of store code SCDᵢ for an store i and a field of an in-stock item list 140.i received from the store i and obtaining a well-known inverted file of the generated file. Each record of the thus generated item-to-store table or file 220 comprises an item code field and a stock-keeping store list field 221. This file 220 makes it possible to know the stores that keep the stock of a certain item.

Also, the center computer 21 creates a set 230 of store data files 100.1 through 100.N received from the store systems 10.1 through 10.N, respectively, by storing the received store data files 100.1 through 100.N in an identical directory or folder.

It is noted that a sale or a buying-in of an item in actual operation causes the value of stock field 131 to change. If the stock field 131 value for an item has changed either from a non-zero value to zero or from zero to a non-zero value in a store system 10.i, then CPU 11.i has to send a message to this effect to the center computer 21, so that the center computer 21 can update the item-to-store table 220 accordingly.

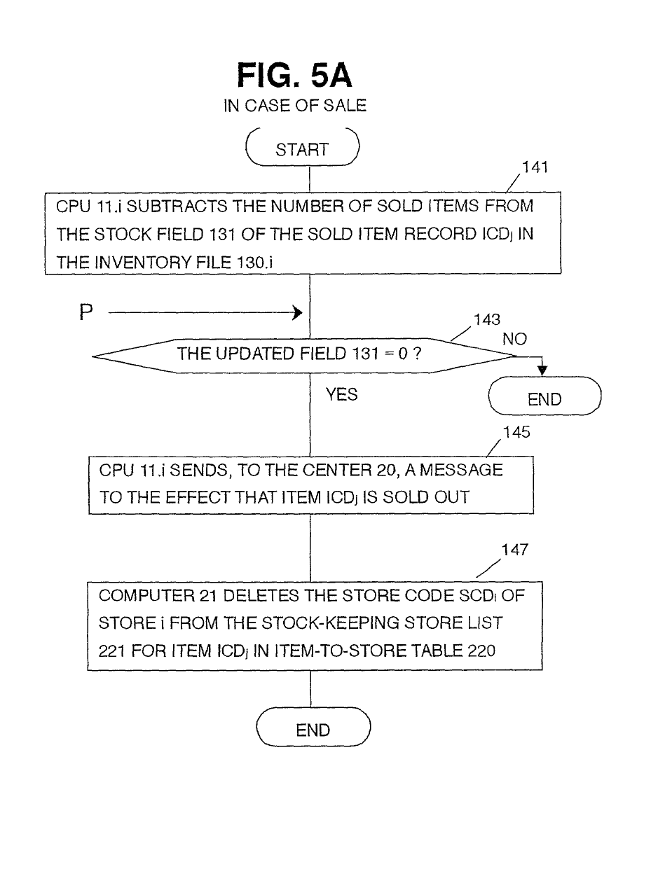

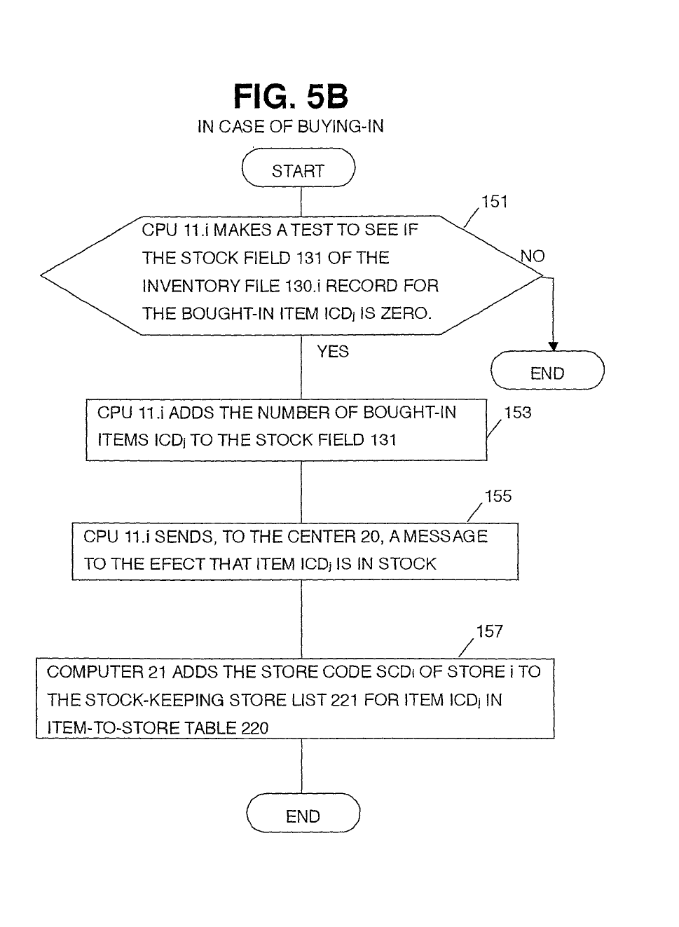

FIGS. 5A is a flowchart showing the operation to update the item-to-store table 220 within center computer 21 in response to a sale of an item identified by an item code ICDⱼ and occurred in store i. In FIG. 5A, CPU 11.i subtracts the number of sold items from the stock field 131 of the sold item record ICDⱼ in the inventory file 130.i in step 141. CPU 11.i makes a test in decision step 143 to see if the value of the updated field 131 .i is zero. If not, then CPU 11.i ends this operation. If the result is YES in decision step 143, then CPU 11.i sends, to the center 20, a message to the effect that item ICDⱼ is sold out in step 145. Responsively, computer 21 deletes the store code SCDᵢ of store i from the stock-keeping store list 221 for item ICDⱼ in item-to-store table 220 in step 147, and ends the operation of FIG. 5A.

FIGS. 5B is a flowchart showing the operation to update the item-to-store table 220 in response to a buying-in of an item identified by an item code ICDⱼ in store i. In FIG. 5A, CPU 11.i makes a test in step 151 to see if the stock field 131 of the inventory file 130.i record for the bought-in item ICDⱼ is zero. If not, then CPU 11.i ends this operation. If the result is YES in decision step 151, then CPU 11.i adds the number of bought-in items to the stock field 131 in step 153. In step 155, CPU 11.i sends, to the center 20, a message to the effect that item ICDⱼ is in stock. Then, the computer 21 responsively adds the store code SCDᵢ of store i to the stock-keeping store list 221 for item ICDⱼ in item-to-store table 220 in step 157, and ends the operation of FIG. 5B.

The above-described operations of FIGS. 5 make it possible to inform the center computer 21 which stores keep a stock for each item without letting the center computer 21 know the stock of each item.

It is also noted that if any alteration is made to the item data table 110.i in a certain store i, then the store information management system 10.i sends the changed, added or deleted record ICDⱼ with the store code SCDᵢ and a code indicative of the kind of alteration to the center computer 21. This enables the center 21 to make an appropriate alteration in the item data table set 200 and, if necessary, in the item-to-store table 220.

### Operation of an Illustrative Embodiment of the Invention

Since basic data are prepared as described above, some exemplary operations of the purchase support system 1 are described in the following.

### Stock-keeping Store Retrieval Function

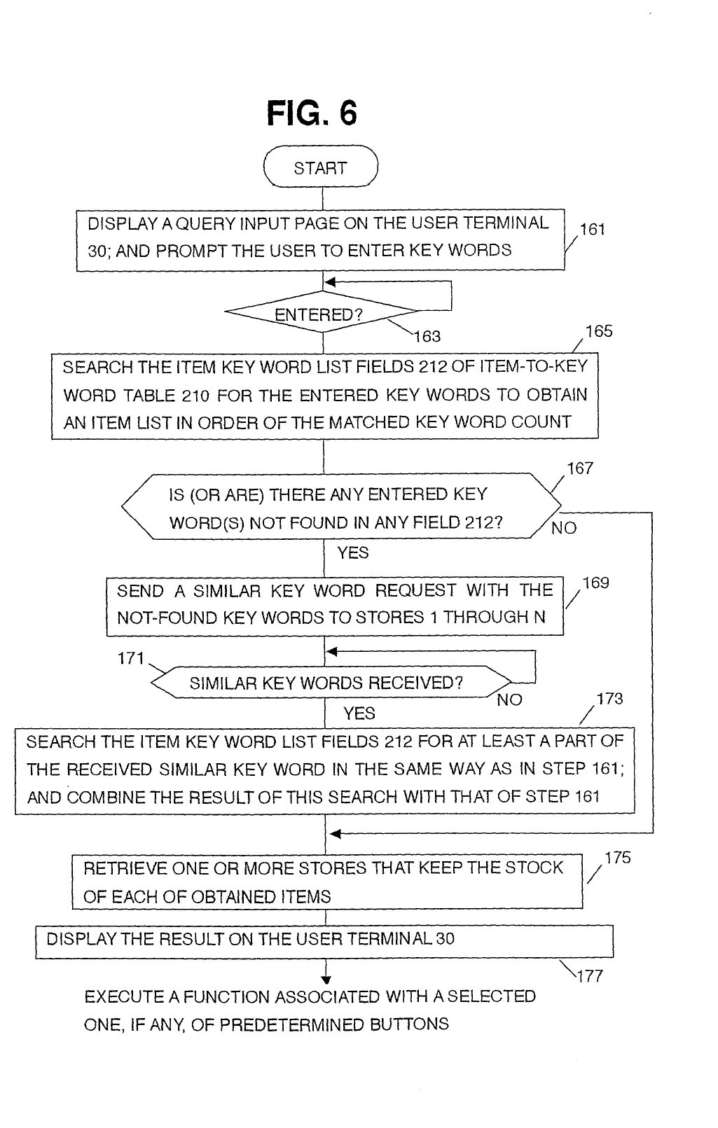

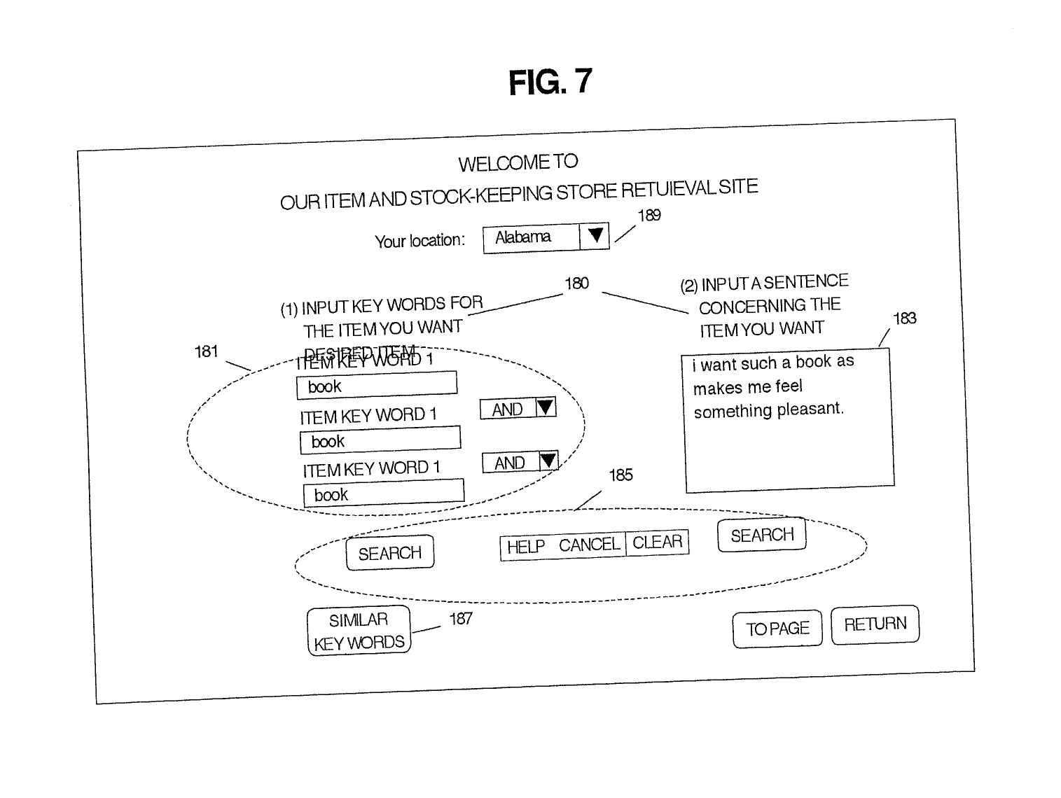

FIG. 6 is a flowchart showing an exemplary operation the center system 20 executes to effect the stock-keeping store retrieval function used in step 41 of FIG. 2 in accordance with an illustrative embodiment of the invention. If the user clicks a button for the purchase support service in a web site provided by the center system 20, then the system 20 (accurately speaking, the WWW server 22 in this specific example) invokes the stock-keeping store retrieval program to enter the operation of FIG. 6. In step 161, the server 22 displays a query input page on the user terminal 30 to prompt the user to enter query data. FIG. 7 is a diagram showing an exemplary query input page displayed in step 161. In FIG. 7, there are shown an expression 180 for prompting the user to enter query data, at least one query data entry form 181 and 183, and various command buttons 185 that enable the user to control the retrieval operation. It is also noted that the user can input information on the location where the user is through a button 189. As seen from FIG. 7, the query data may be either in the form 181 of key words or in the form 183 of a natural language. However, in order to simply the description, it is assumed that the user has entered some key words concerning an item he seeks in the following description. It should not be taken as a limitation to the invention.

In decision step 163, the server 22 waits for the query data from the user in step 163 and, if received it from the querying user, proceeds to step 165.

In step 165, the server 22 simply passes the received query data (key words in this example) to the computer 21, which in turn searches the item key word list fields 212 of item-to-key word table 210 for the entered key words to obtain an item list, for example, in the descending order of the matched key word count.

It is also noted that as seen from the description so far, the operation of FIG. 6 is executed by the server 22 and the computer 21 in concert with each other. Since how they bear their share of operation depends on the configuration of the center system 20 and is accordingly, not essential. The operation of FIG. 6 and the other operations in the subsequent description can and should be considered to be executed by the center system 20. From the point of computer 21, the LAN 23, the server 22 and the router 24 serves as an Internet interface for providing an access to the Internet 27. It is also possible to think that the entirety of the elements 22 through 30 plays a role of an human interface (i.e., input and output devices for user) of the center computer 21. For this reason, in reading the operation descriptions, it is possible, appropriate and strongly recommended for correctly understanding the principles of the invention to neglect the expressions such as “the server 22 passes so-and-so to the computer 21” and “the computer 21 returns (passes) so-and-so to the server 22” and to read both “the computer 21” and “the server 22” as—the (center) system 20—. Therefore, though the specification is written by using “the computer 21” and “the server 22” for the purpose of description, it is assumed that the subject is “the system 20” in the flowcharts.

Turning back to FIG. 6, in decision step 167, the computer 21 makes a test to see if there is (or are) any entered key word(s) not found (referred to as “not-found key word(s)”) in any field 212. If so, then judging the item retrieval to be successful, the computer 21 proceeds to step 175.

Otherwise, the computer 21 sends a similar key word request with the not-found key word(s) to the store systems 10.1 through 10.N in step 169 and waits for similar key words from the store systems 10 in step 171. Responsively, each store system 10.i searches the similar key word list field 124 for each of the not-found key word(s). This search is done in such a way that if a certain not-found key word hits a match in a certain record, then the matched word is collected. For example, in FIG. 3D, if a word “lucky” is one of the not-found key words, then at least “happy” and “merry” is collected. Each store system 10.i returns thus collected similar key words to the center computer 21.

On receiving the similar key words, the computer 21 searches, in step 173, the item key word list fields 212 for at least a part of the received similar key words in the same way as in step 161, combines the result of this search with that of step 161 to obtain the final results of the item retrieval; and proceeds to step 175.

Then, in step 175, the computer 21 retrieves one or more stores that keep the stock of each of obtained or retrieved items. In step 177, the computer 21 prepares a result display page by using various data concerning at least a part of the retrieved items and corresponding stock-keeping stores, and returns the prepared result display page to the server 22. The server 22 responsively transmits the result display page to the querying user. On receiving the result display page, the user terminal 30 of the querying user displays the result display page on the display portion thereof. Thereafter, the center system 20 executes a function associated with a selected one, if any, of predetermined buttons displayed in the result display page.

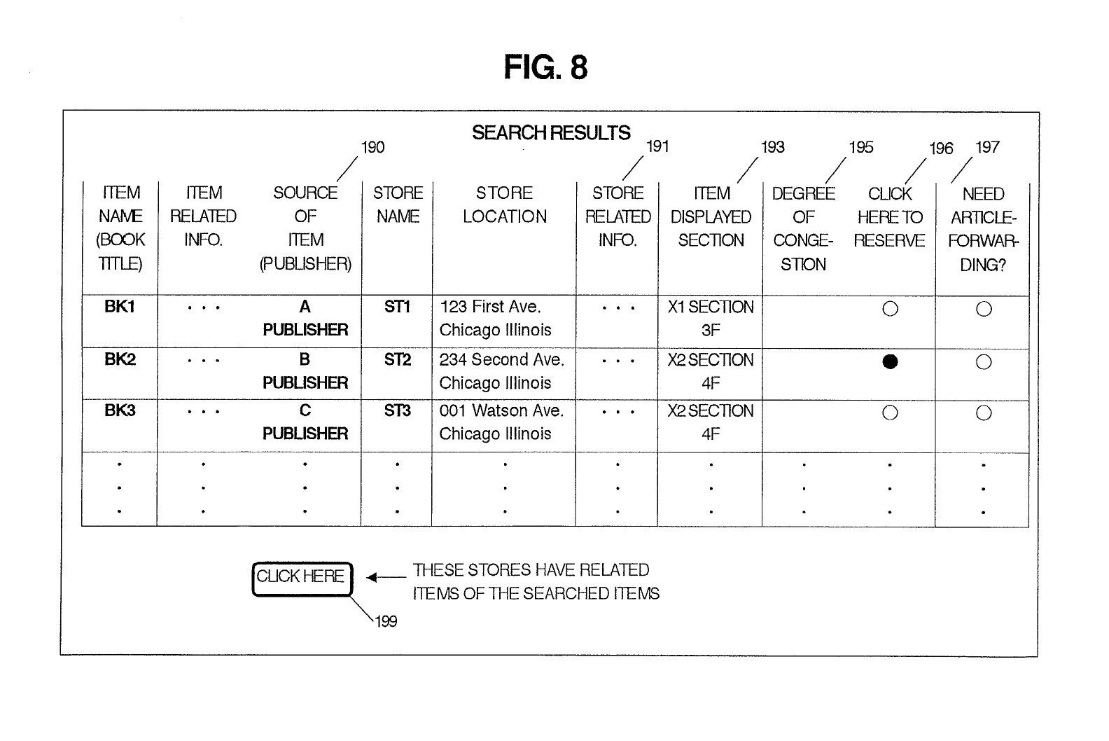

FIG. 8 is a diagram showing an exemplary search result display page displayed in response to a clicking of the “search” button of FIG. 7. In FIG. 8, retrieved items are shown in horizontal lines. Each item record includes, for example, the item name, other item related information, the source 190 of the item such as publisher, manufacture or the like, at least one store name which keeps the stock of the item, the store location, other store related information 191, item displayed section (or corner) 193, the degree 195 of congestion near the item displayed section, a reservation button 196 which is to be clicked for reserving the item at the store and indicates whether the item is reserved at the store or not, and an article-forwarding button 197 which is to be clicked for more information on other stores providing the article-forwarding service and indicating whether the user has made an article-forwarding reservation for the item at the store. The functions of buttons 196 and 197 will be detailed later.

It is noted that any information contained in the store data files 100.1 through 100.N and the item data tables 110.1 through 110.N can be shown in the search result display page of FIG. 8 and the pages linked from the search result display page of FIG. 8. It should be noted that though we have displayed the search result in the table form, there are various ways of displaying the search result.

The texts printed in bold types and buttons (denoted by small circles) in the result display table can be clicked and are associated with respective functions or URLs (Uniform Resource Locator). For example, if an Item name, an item source 190, or a store mane is clicked, then the center system 20 will display detailed information on the item, the item source, or the store, respectively.

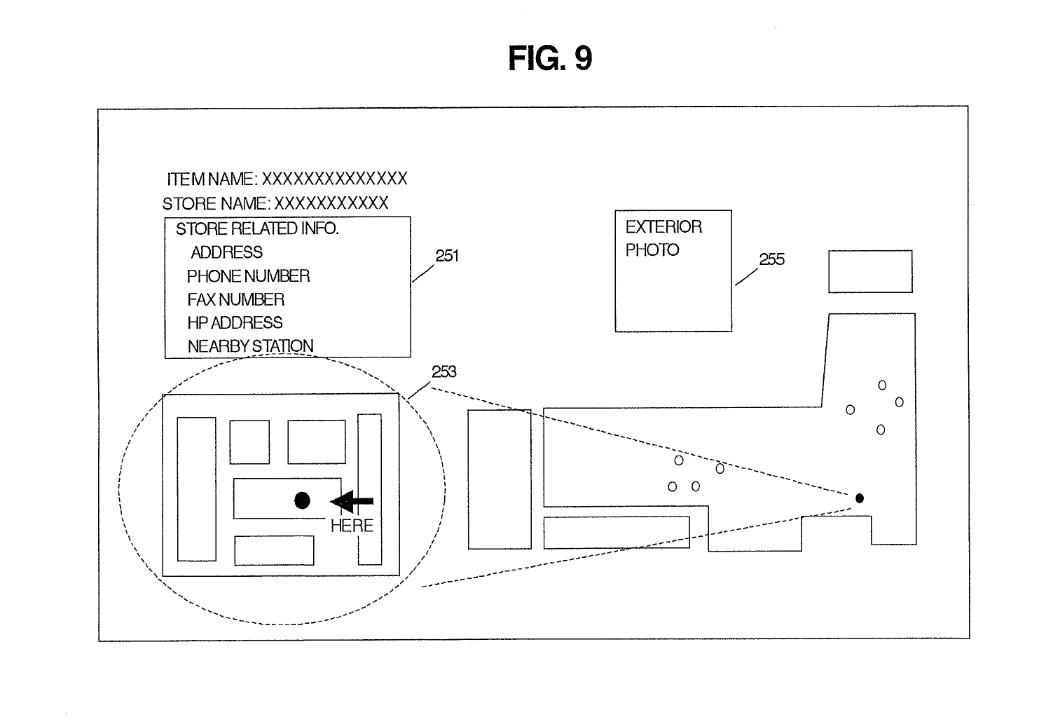

FIG. 9 is a diagram showing an exemplary detailed store information display page displayed in response to a clicking of a store name (one of ST1-ST3 in this specific example) on the search result display page of FIG. 8. In FIG. 8, there are shown various pieces 251 of information, an exterior photograph 255 of the store, and a map having the store thereon.

### Related Item Search

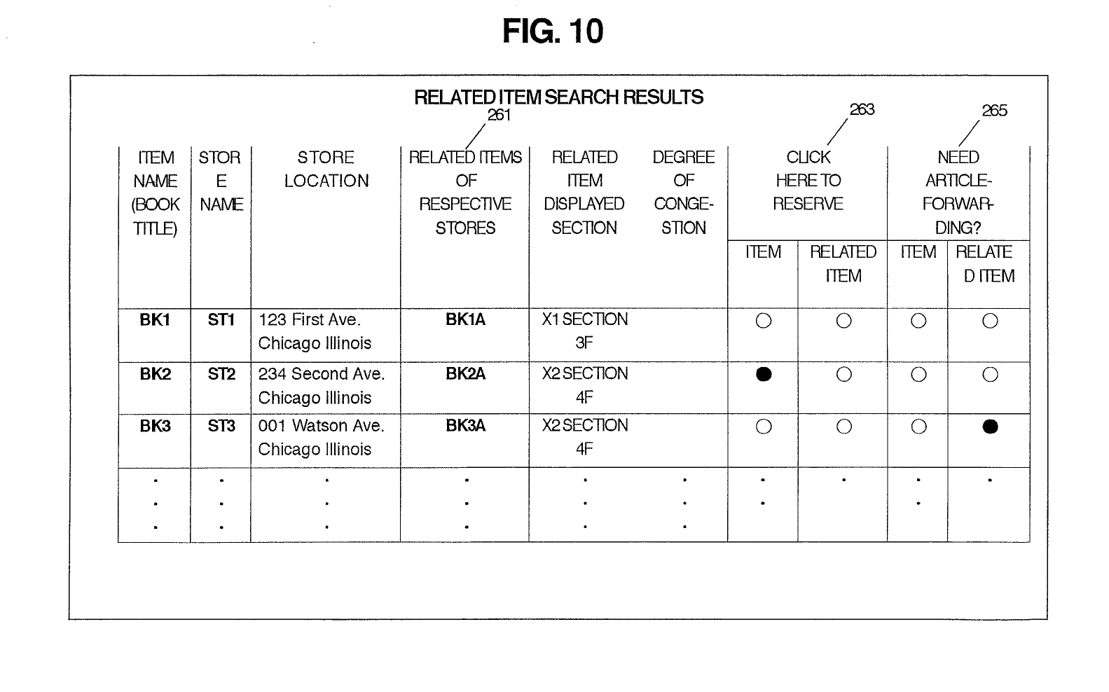

FIG. 10 is a diagram showing an exemplary related item search result display page displayed in response to a clicking of the “CLICK HERE” button 199 of FIG. 8. The stores listed in the store name column are usually dealing with and keeps the stock of some items relating or similar to the retrieved items. If the user desires to get some information on such related items, then he or she has only to click the button 199. Then, the center computer 20 displays a related item search results as shown in FIG. 10. FIG. 11 is a flowchart showing an exemplary related item retrieval operation. In response to a click of button 199, the center 20 sends a similar key word request with the entered key words (entered in step 161 of FIG. 6) to at least a part of the stores: e.g., the stores listed in the store name column of FIG. 8 in step 301. In response to a reception of similar key word request, each of the stores that received the request searchs, in step 303, the item key word fields 122 of the similar key word file 120.i for the entered key words to obtain similar key words from the field 124; and returns the obtained similar key words to the center 20. Responsively, the center 20 retrieves related items from the item-to-key word table 210 by using at least a part of the received similar key words in step 305. Then, in step 307, the center 20 selects the related items that are kept in stock by the stores listed in the store name column of FIG. 8. Finally, the center 20 displays the result on the user terminal 30 in step 309 and end the operation.

Turning now to FIG. 10, a related item column 261 is displayed following the store location column. It is also noted that the reservation buttons 263 and the article-forwarding buttons 265 are provided for both the originally retrieved items and the related items.

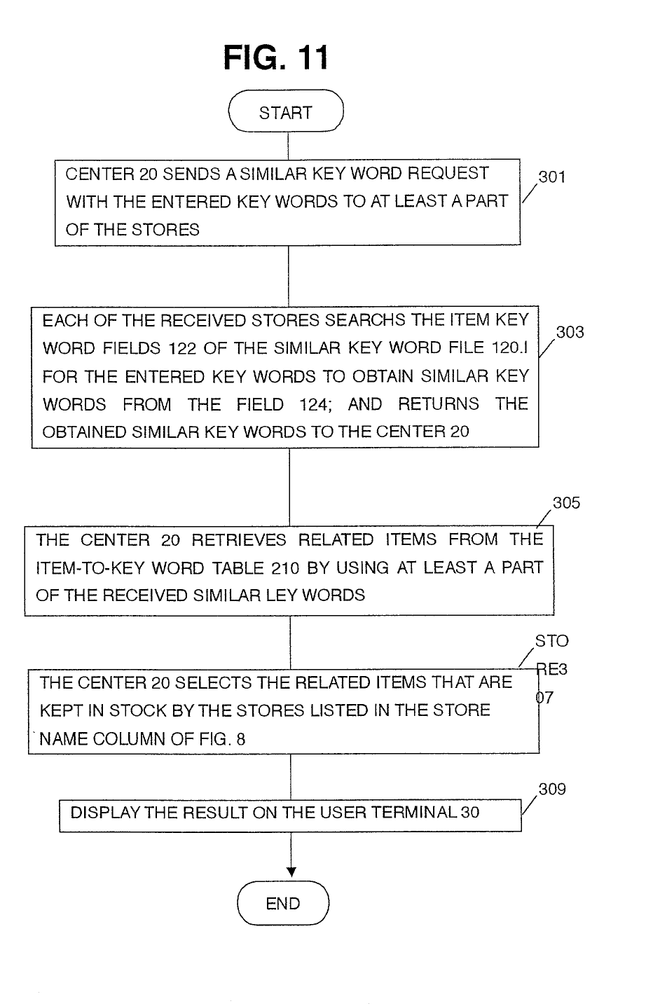

FIG. 12 is a diagram showing an exemplary data file 320 maintained by each store system 10.i for use in the calculation of the degree of the congestion as shown in FIGS. 8 and 10. The data file 320 contains the records for all the item displayed sections. Each record of the file 320 comprises an item displayed section 321, a sales count 323 for a shorter period (e.g., for the last 10 minutes), a sales count 325 for a longer period (e.g., for the one hour) and the degree 329 of congestion. In response to every sale of any item, the sale counts 323 and 325 of the item displayed section 321 for the sold item are incremented. The sales counts 323 and 325 are reset to zero every respective periods. The degree of congestion 329 is calculated by comparing thus obtained sale counts 323 and 325 with respective reference values that have been statistically obtained. For this calculation, other data 327 obtained by using some sensor for detecting a human body or a movement of human body may be used.

As described above, according to the invention, the user can get information on not only items that match the key words specified by the user but also stores that keep the stock of the retrieved items.

### Modification I

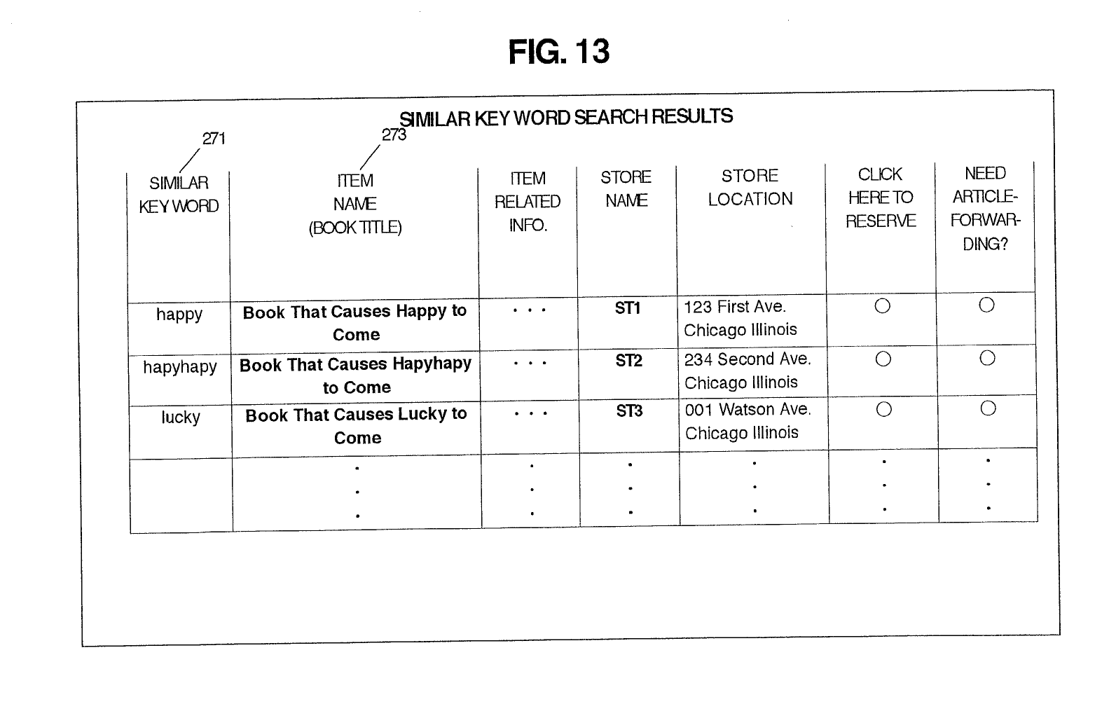

In the above embodiment, the similar key word file 120.i are created by each store system 10.i. Alternatively, the center system 20 may generate and maintains a similar key word file (not shown). In this illustrative embodiment, the query input page of FIG. 7 may include a similar key word display button 187. If the similar key word display button 187 is clicked, then the center 20 first retrieves similar key words from the not-shown similar key word file by using the key word input by the user in the manner as described in connection with the step 169 of FIG. 6. Then, the center 20 retrieves items and stock-keeping stores from the item-to-key word table 210 and the item-to-store table 220 of FIG. 4 by using the retrieved similar key words. FIG. 13 is a diagram showing an exemplary similar key word search result display page displayed in response to a clicking of the “SIMILAR KEY WORDS” button of FIG. 7. In FIG. 13, there are shown a similar key word column 271 which contains key words similar to the user specified key words, an item name column 273 which contains item names retrieved by using the similar key words 271, and a store name column which contains the names of stores that keeps the stock of retrieved items.

### Modification II

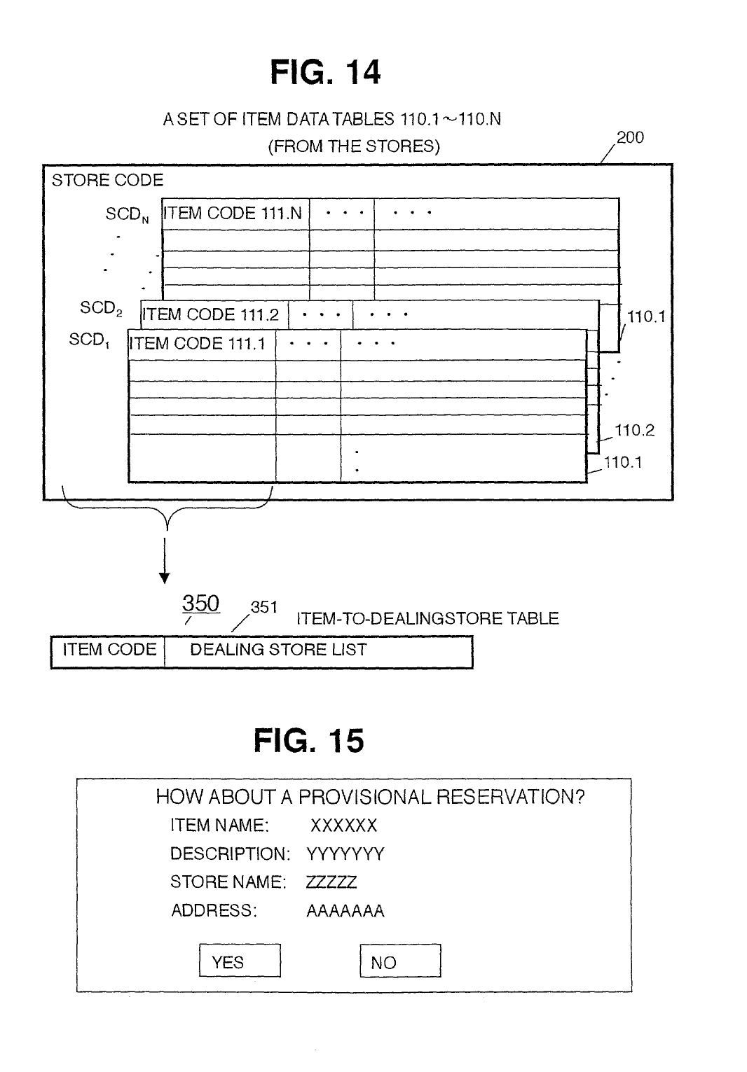

In the above illustrative embodiment, each store system 10.i has sent its in-stock item list 140.i, and the center 20 has generated the item-to-store table 220 from the received in-stock item lists 140.1 through 140.N. The stock-keeping stores have been found from the item-to-store table 220. Instead of generating the item-to-store table 220, the center 20 may generate an item-to-dealing store table as shown in FIG. 14. In FIG. 14, the item-to-dealing store table 350 is obtained by generating an inverted file from the store codes SCD₁ through SCD_{N} and the item codes of the item data table set 200. Each record of the item-to-dealing store table 350 comprises an item code SCDi and a dealing store list that contains the store codes of the stores dealing the item identified by SCDi.

In a retrieval operation, the center 20 first retrieves items that match the user key words and knows the dealing stores for the retrieved items by using the item-to-dealing store table 350. Then the center 20 sends a stock information request only to the dealing stores.

### Modification III

In the above embodiment, the data of FIGS. 3 are managed by each store system 10.i. However, it is possible to manage all of the data in the center 20. In this case, input data of each store system 10.i is transmitted to the center 20 in real time. Anonymous Reservation (step 43 of FIG. 2)

FIG. 15 is a diagram showing an exemplary reservation request page displayed in response to a click of any reservation buttons in the “click here to reserve” column 196. In FIG. 15, if the user selects a button indicating the intention of making a provisional reservation: i.e., “YES” button in this example, then the purchase support system 1 enters into an anonymous reservation operation.

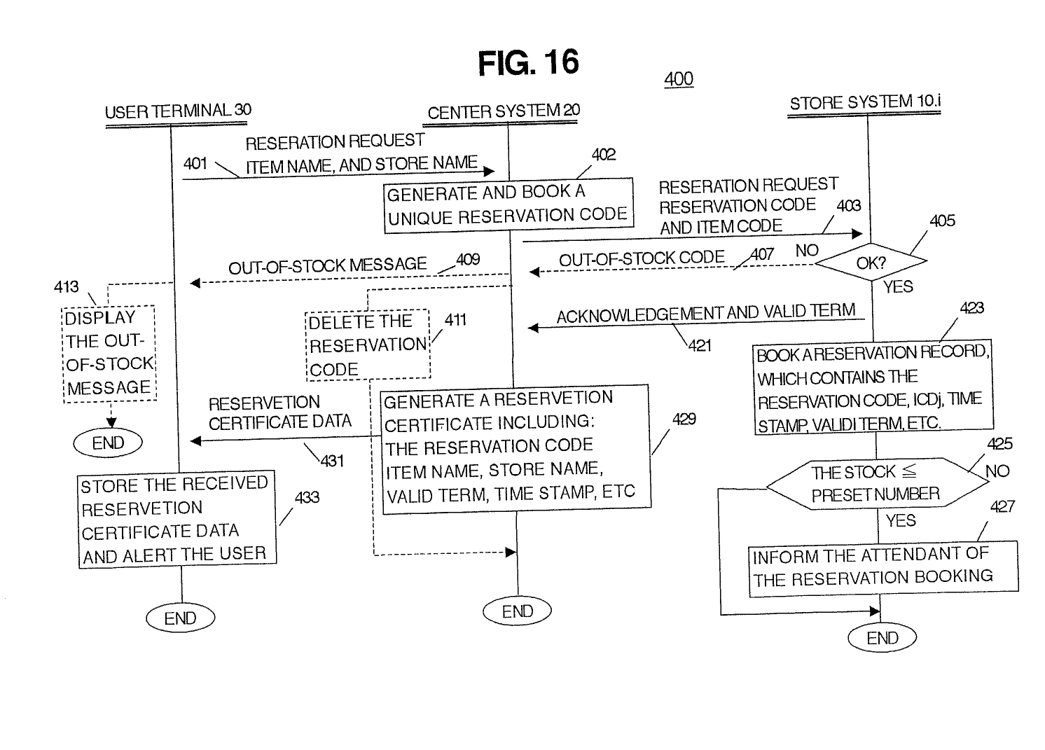

FIG. 16 is a flow diagram showing the flows of data and operation involved in an anonymous reservation in accordance with the present invention. In step 401, the user terminal 30 sends a provisional reservation request, a user-specified item name and store name to the center 20. The center 20 responsively generates and books a unique reservation code in step 402, and sends the provisional reservation request, the reservation code and the item code for the item name to the store system 10.i identified by the received store name in step 403. The store system 10.i makes a check of the inventory file 130.i to see if the reservation is acceptable in step 405.

If not, then the control flows along dashed lines. That is, in step 407, the store system 10.i sends a code indicative of the out-of-stock state to the center system 20, which in turn sends a message representative of the out-of-stock state to the user terminal 30 in step 409, deletes the reservation code in step 411 and exits from the operation 400. In response to a reception of the out-of-stock message, the user terminal 30 displays the out-of-stock message in step 413 and exits from the operation 400.

If the result is YES in step 405, then the store system 10.i sends an acknowledgement and the valid term of the reservation to the center system 20 in step 421 and books a reservation record in step 423.

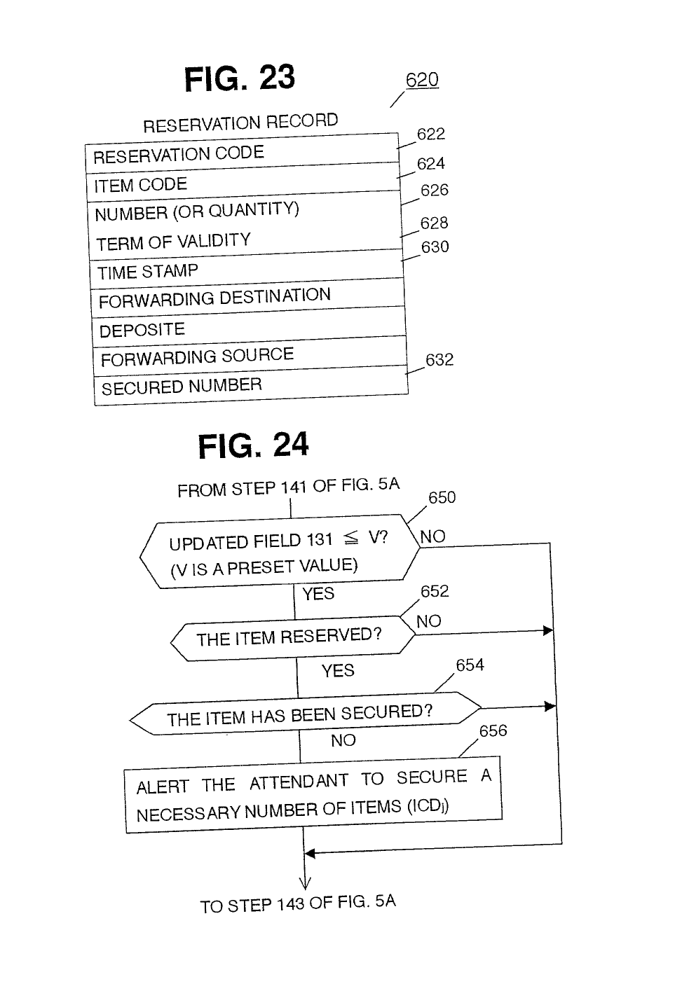

FIG. 23 shows an exemplary arrangement of a reservation record in accordance with an illustrative embodiment of the invention. In FIG. 23, the reservation record 620 contains a reservation code 622, an item code 624, the number (or quantity) 626 of the reserved item, the term 628 of validity, the time stamp (i.e., time and date of this transaction) 630, and a secured number 632 indicative of the number of items that have been actually secured by, for example, moving reserved items from the displayed place to some other place unreachable from customers.

Following step 423, the store system 10.i makes a test to see if the stock of the reserved item is equal to or fewer than a predetermined number in step 425. If not or there is a sufficient stock of the item, then the store system exits from the operation 400. If the result is YES in step 425, then the store system 10.i informs the attendant of the reservation booking by generating an alerting sound, displaying a message and/or printing a message in step 427. This enables the attendant to reserve an item specified by the user by, for example, moving the item from the display location to some customer-unreachable place or attaching a printed tag indicating that the article is reserved to the article. Doing this makes it possible to avoid a situation in which when a customer brings an article that is the last one left in stock the attendant has to tell the customer that they can not sell the article due to a previous reservation, which will make the customer unpleasant. After step 427, the store system exits from the operation 400.

On the other hand, when the center system 20 receives the acknowledgement and the valid term, the center 20 generates 429 and sends 431 a provisional reservation certificate data specifying the reservation code, the item name (and code), the store name (and code), the term of validity, time stamp, etc. to the user terminal 30 and exits from the operation 400.

In response to a reception of the provisional reservation certificate data, the user terminal 30 stores the he provisional reservation certificate data and alerts the user by displaying a message to the effect that the reservation was booked and/or transmitting a predetermined sound in step 433. For this purpose, the user terminal 30 is preferably provided with a program for executing the function of step 433. After step 433, the user terminal 30 exits from the operation 400. This completes a booking of an anonymous reservation according to the invention.

According to the principles of the invention, the user can make a reservation for a desired item without disclosing his or her personal information such as the name, address, telephone number, etc.

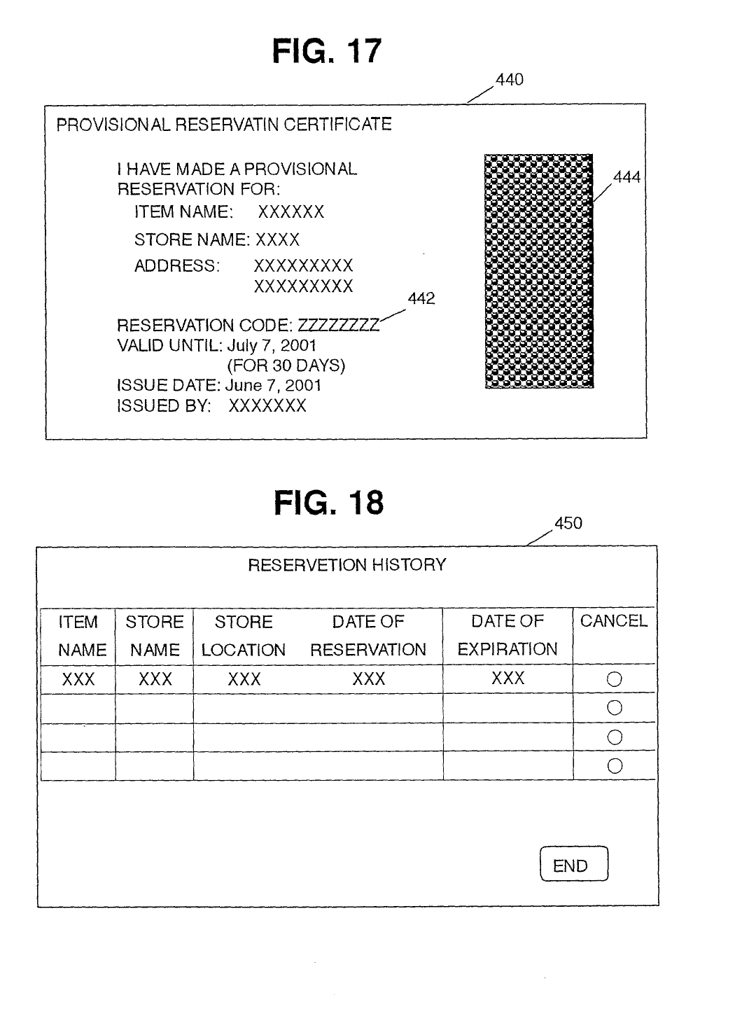

FIG. 17 is a diagram showing an example of a provisional reservation certificate issued in response to a booking of an anonymous reservation. In FIG. 17, the certificate 440 specifies various pieces of data. However, the most important information is the reservation code 442 because it is the only information used for the authentication in a purchase transaction for the reservation. The other text information is intended for memorandum for the user. Also, the certificate 440 may have some machine-readable code 444 printed so that the reservation code 442 can be read by an appropriate machine. When the provisional reservation certificate 440 is used for purchase of reserved item, the provisional reservation certificate 440 may be either printed or displayed and presented to the store attendant.

Once a reservation is booked, the contents of the reservation can be checked by displaying a reservation history as shown in FIG. 18 through a predetermined operation for issuing a reservation history display command. In FIG. 18, the reservation history display 450 includes, for example, item name, store name, store location, date of reservation, date of expiration, and a cancel button for each of the reservations the user has made so far. The user can cancel any reservation by simply clicking the cancel button of a desired reservation.

As described above, the use is permitted to make an anonymous reservation for any of the retrieved items in a retrieval result displaying page as shown in FIGS. 8, 10 and 13. However, the stock-keeping store of the item for which the user desires to make a reservation is not necessarily very near to the user. In order to cope with such a situation, the invention provides an article-forwarding reservation function as shown in FIG. 2.

### Article-forwarding Reservation

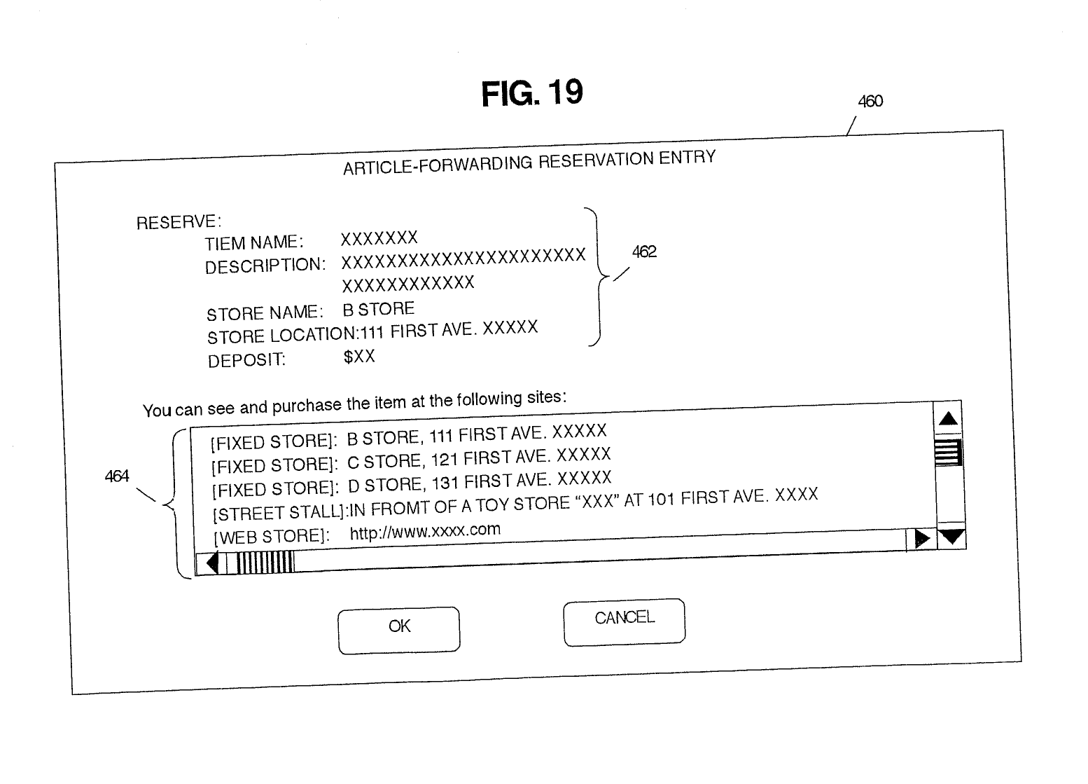

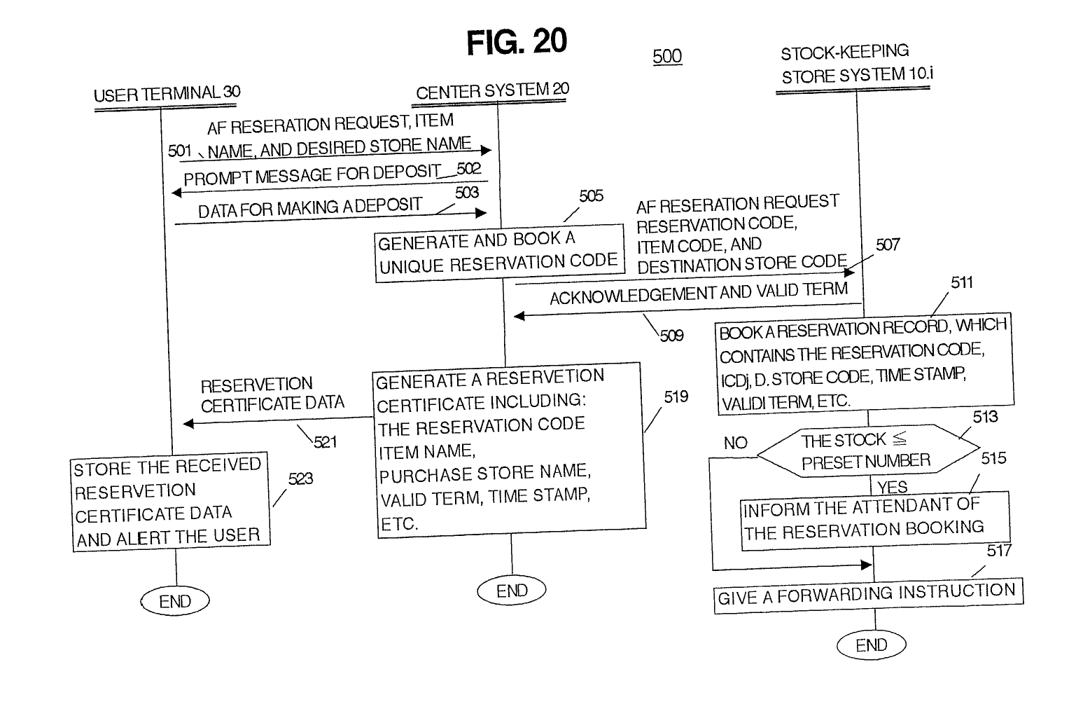

The article-forwarding reservation is initiated by clicking a button of the “NEED ARTICLE-FORWARDING?” column in a desired item record in pages shown in FIGS. 8, 10 and 13. If such a button is clicked, then the center 20 displays an article-forwarding reservation entry page as shown in FIG. 19. In FIG. 19, the entry form 460 includes information 462 on a reserved item and a dealer of the item, and information on stores or sites where the user can see and purchase the item specified in the upper column 462 regardless of whether the stores currently keep a stock of the specified item. It is noted that the stores user can purchase an item through an article-forwarding reservation includes street stalls and virtual stores on the web (or web stores) as well as usual fixed stores. Selecting one of the displayed sites and clicking a button indicative of an approval (a button labeled “OK” in this example) initiates an article-forwarding reservation booking operation in accordance with the invention. FIG. 20 shows this operation 500.

If the user clicks the OK button of FIG. 19, then the user terminal 30 sends an article-forwarding (AF) reservation request, a user-specified item name and a desired store name of the store j from which the user desires to buy the item to the center 20 in step 501. The center 20 responsively prompts the user to make a predetermined deposit in step 502. Then, the user sends information necessary for paying the deposit to the center computer 20 in step 503.

In response to the user making a deposit, the center 20 generates and books a unique reservation code in step 505. Further, in step 507, the center 20 sends the AF reservation request, the reservation code, the item code for the item name and the destination store code SCDj to which the item is to be forwarded to one 10.i of the store systems or stores which keep a stock of the user specified item in step 507. Responsively, the store system 10.i sends an acknowledgement and a valid term to the center 20 in step 509, and books a reservation record 620 which contains the reservation code 622, the item code, the destination store code SCDⱼ, the term 628 of validity, the time stamp 630 (as shown in FIG. 23) in step 511. Then, the store system 10.i makes a test to see if the stock of the reserved item is equal to or fewer than a predetermined number in step 513. If not or there is a sufficient stock of the item, then the store system proceeds to step 517. If the result is YES in step 513, then the store system 10.i informs the attendant of the reservation booking by generating an alerting sound, displaying a message and/or printing a message in step 515, and proceeds to step 517.

In step 517, the store system 10.i gives the attendant an instruction to forward the reserved article to the destination store SCDⱼ by displaying a suitable message and/or transmitting a suitable sound. After step 517, the store system exits from the operation 500.

On the other hand, when the center system 20 receives the acknowledgement and the valid term, the center 20 generates 519 and sends 521 a AF reservation certificate data specifying the reservation code, the item name (and code), the purchase (or destination) store name (and code), the term of validity, time stamp, etc. to the user terminal 30 and exits from the operation 500.

In response to a reception of the AF reservation certificate data, the user terminal 30 stores the he AF reservation certificate data and alerts the user by displaying a message to the effect that the reservation was booked and/or transmitting a predetermined sound in step 523. This completes a booking of an article-forwarding reservation according to the invention.

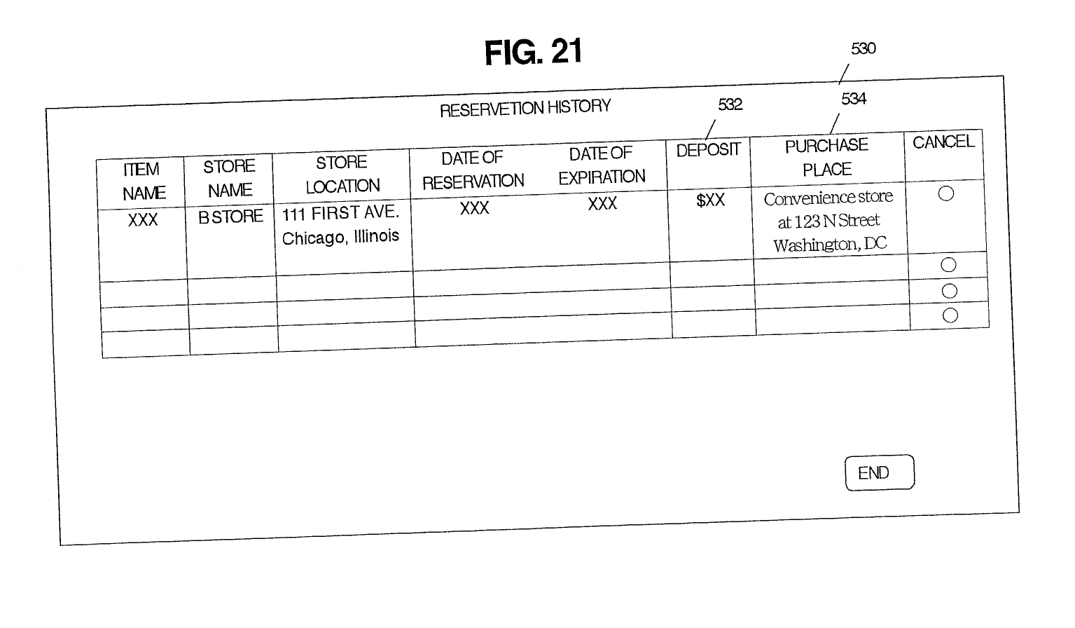

The reservation history display page 450 of FIG. 18 is preferably to modify to one shown in FIG. 21. The reservation history display page 530 includes a deposit column 523 and a purchase place column 534 so as to be applicable to the article-forwarding (AF) reservation. For the same reason, The provisional reservation certificate issued in step 519 is preferably modified to include columns in which the deposit the user have paid and the purchase place or store are specified.

In the above-described anonymous reservation (FIG. 16) and item-forwarding reservation (FIG. 20), each store information management system 10.i has managed reservation records 620 for all the reservations the store i has accepted. However, the center computer 21 may collect the reservation records from all the store systems 10.1 through 10.N and manage the collected reservation records 620. In order to realize this scheme, each time the store system 10.i books a reservation record, each store system 10.i has to send the reservation record to the center system 20, which stores the received reservation record in the mass storage 25.

It is noted that it is preferable for the center computer 21 to keep an item (article) forwarding list arranged according to the destinations and the forwarding dates from the reservation records which each include a forwarding destination (i.e., a store specified by a user as a purchase place) and to control the store systems 10 to forward the AF reserved articles from the forwarding sources (or stores keeping the AF reserved articles in a stock) according to the item forwarding list by using any suitable transport means.

It is also preferable for the center system 20 to totalize the kinds and the numbers of items required by each store through the collection and analysis of reservation data or the reservation records and to instruct the store systems 10 to adjust the kinds and the numbers of items among themselves. In this case, if one or more cancel is found in the AF reservation for an identical article and if the location of destination store of any not-canceled AF reservation is the same or near to that of the canceled destination store, then an available article may be efficiently utilized.

### Reservation Record Management (step 53 of FIG. 2)

Once an anonymous reservation or an AF reservation has been booked, the system 1 enters the reservation record management for the booked reservation as shown in FIG.2. In FIG. 2, the reservation record management comprises a timeout transaction 52, a purchase transaction 48 and a cancel transaction 50, which simply deletes a relevant reservation record in response to a cancel request from a user.

A program for timeout transaction 52 periodically makes a test to see if there is (or are) any reservation(s) that has expired, and, if any, deletes the record(s) for the timeout reservation from a reservation record file (not shown).

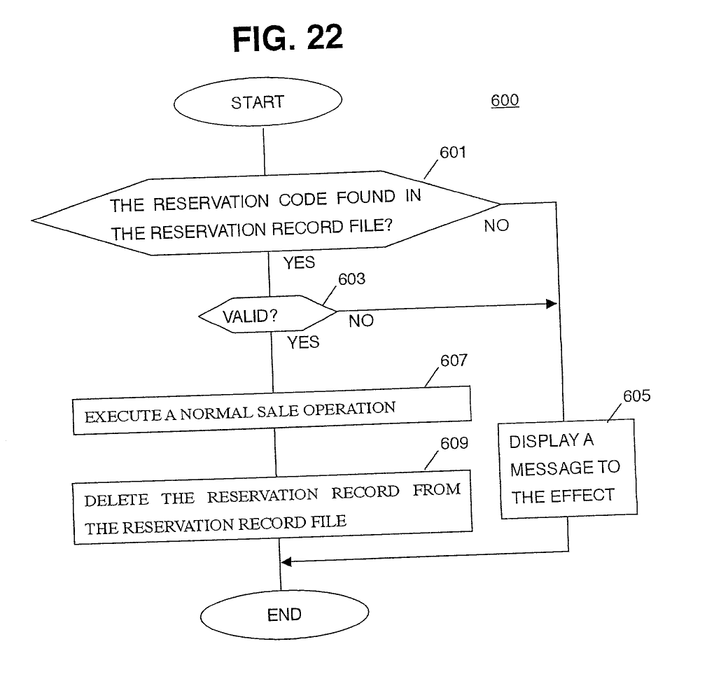

FIG. 22 is a flowchart showing an exemplary purchase operation executed in step 48 of FIG. 2. When a customer who has made a reservation comes to a store, then the attendant inputs the reservation code from the printed reservation certificate the customer has brought or by reading the displayed reservation code on the user terminal 30. In response to an input of a reservation code, the purchase program 600 of FIG. 22 is invoked. In FIG. 22, the store system 10 makes a test to see if the reservation code is found in the reservation records 620 in step 601. If so, then the system 10 makes a test to see if the reservation is valid or within a predetermined time limit from the reservation time in step 603. If so, then the system 10 executes a normal sale operation in step 607, and deletes the reservation record identified by the reservation code from the reservation record file in step 609. If the test result is NO in step 601 or 603, then the system 10 displays an appropriate message in step 605. After step 605 or 609, the system 10 ends the operation 600.

By doing this, the reservation record management is achieved. It is noted that if the above-mentioned timeout transaction is normally executed, the decision step 603 can be omitted.

What should be avoided in a reservation-based system is to make a reservation-booked item out of stock. For this reason, it is preferable to add a selling-out prevention function in the sale-related operation of FIG. 5A.

FIG. 24 is a diagram showing a partial operation flow that, when inserted in the path (denoted P) between steps 141 and 143 of FIG. 5A, adds a selling-out prevention function. In FIG. 24, CPU 11.i makes a test to see if the updated field 131 is equal to or smaller than a predetermined value V in step 650. If so, another test is made by checking the reservation records 620 to see if the item has been reserved in step 652. If so, then further test is made by comparing the number 626 and the secured number 632 in the reservation record 620 to see if necessary item(s) has (or have) been secured in step 654. If not, then CPU 10.i alerts the attendant to secure a necessary number of items in step 656, and proceeds to step 143 of FIG. 5A. If the result is NO in step 650 or 652, or if the result is NO in step 654, then CPU 10.i simply proceeds to step 143 of FIG. 5A.

If a purchase support system 1 is so configured as to manage the reservation records not only in each store system 10.i but also in the center system 20 as mentioned above as a form of modification, then a purchase or selling operation is executed in the following manner when a customer who has made a reservation comes to a store. That is, the attendant of the store inputs the reservation code from the printed reservation certificate the customer has brought or by reading the displayed reservation code on the user terminal 30. In response to an input of a reservation code, the center computer 21 starts executing the purchase program 600 of FIG. 22. If the answer is YES in step 603, then the store system 10.i sends the input reservation code to the center system 20, which responsively executes the same operation as shown in FIG. 22 and returns a code indicating the result of the operation to the store system 10.i. In response to the reception of the code, the store system 10.i operates accordingly.

### Benefit Information Indication

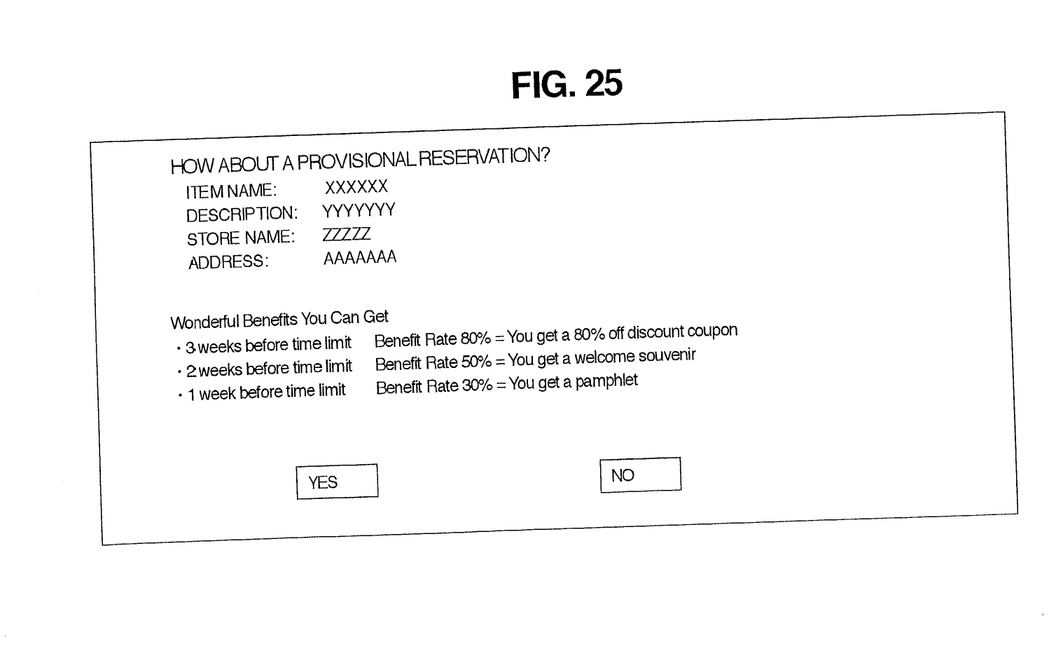

FIG. 25 is a diagram showing an exemplary reservation request (entry) page displayed in response to a click of any reservation buttons associated with a store that offers some form of benefits to customers who have made a reservation and comes to the store within a set time limit. As seen in FIG. 25, information on various benefits may be included in a reservation request (entry) page. The degree of benefits may be determined depending on how early the customer has come after reservation. Displaying such information on various benefits contributes to the collection effect of potential customers.

It is also noted that if the store or item of a reservation is attached with some kind of benefit, then it is preferable to include information on the benefit in the reservation certificate.

### Charging for Article-Forwarding Reservations

Since various purchase support services provided by the center system 20 contribute to the potential customer collection as described above, the center 20 may charge for each AF Reservation. This is achieved by counting, for each store system 10.i, the number Mi of RF reservations whose destination store is 10.i for a predetermined period of time, and charging each store system 10.i for Mi FR reservations.

The foregoing merely illustrates the principles of the invention. Thus, other variations are possible. For example, the valid term or the term of validity may vary item by item. Different valid terms may be set to respective items.

The preset number used in step 425 and 523 may be any suitable integer including one. Also, the preset value used in step 650 may be any suitable value including one. These preset number and preset value may vary item by item. Different preset numbers and values may be set to respective items.

Many widely different embodiments of the present invention may be constructed without departing from the spirit and scope of the present invention. It should be understood that the present invention is not limited to the specific embodiments described in the specification, except as defined in the appended claims.

What is claimed is:

1. A method for permitting a user to input user key words and for providing the user with information on at least one item that match(s) the user key words and, for each provided item, information on at least one store keeping a stock of the provided item in a system comprising a plurality of store apparatuses provided in respective stores, a center apparatus capable of communicating with the store apparatuses, and a user terminal used by the user and capable of communicating with the center apparatus, wherein said at least one item may be article(s) or service(s), the method comprising the steps, executed by the center apparatus, of:
generating a set of unique item codes collected from all stores involved;
assigning each item code item key words suitable to an item identified by the item code to generate a set of relations, each relation associating one of said unique item codes with item key words assigned to the unique item code;
collecting, from each store apparatus, a list of item codes of items kept in stock by the store having the store apparatus;
retrieving item codes from said set of relations by using said user key words;
obtaining store codes associated with each of said retrieved item codes by using all of said lists of item codes; and
providing the user terminal with at least a pert of said retrieved item codes and further providing, for each of at least a pert of said retrieved item codes, at least a part of said obtained store codes.

2. A method as defined in claim 1, further comprising the step of said center apparatus collecting various information associated with each item code and various information associated with each store code from all stores involved and wherein said providing step includes the step of providing at least a part of said various information associated with each of said provided item codes and at least a part of said various information associated with each of said provided store codes.

3. A method as defined in claim 1, further comprising the steps of:
said center apparatus sending a set of unique item key words to each store apparatus; and
each store apparatus assigning similar key words to each item key words in said set to generate a similar key word table, said retrieving step including the steps of:
if there is any user key word that is not found in said item key words, said center apparatus obtaining substitute item key words associated, by said similar key word table, with said any key word from at least one store apparatus;
retrieving additional item codes from said set of relations by using said substitute item key words; and
regarding said retrieved item codes and said additional item codes as a retrieval result.

4. A method as defined in claim 2, wherein said various information associated with each item code includes information on a place where the item is displayed.

5. A method as defined in claim 4, wherein said providing step includes displaying a degree of congestion of said place.

6. A method as defined in claim 1, wherein said providing step includes the step of displaying, on the user terminal, a button that enable the user to instruct the system to display similar key words similar to the user key words, and wherein the method further comprises the steps of:
said center apparatus sending a set of unique item key words to each store apparatus;
each store apparatus assigning similar key words to each item key words in said set to generate a similar key word table:
in response to a detection of a predetermined operation of said button by the user, said center apparatus obtaining said similar key words associated, by said similar key word table, with the user key words from at least one store apparatus;
retrieving item codes from said set of relations by using said similar key words; and
causing the user terminal to display at least a part of said similar key words and information on items identified by at least a pert of said retrieved item codes.

7. A method for permitting a user to have a desired item reserved by a store without letting the store know any private information in a system comprising a plurality of store apparatuses provided in respective stores, a center apparatus capable of communicating with the store apparatuses, and a user terminal used by the user and capable of communicating with the center apparatus, wherein the desired item may be an article or service, the method comprising the steps of:
(a) in response to a request from the user, the center apparatus presenting a plurality of item identifiers of items available from said respective stores and a store identifier of a store that keeps a stock of each of said available items;
(b) the center apparatus prompting the user to make a reservation for one of said retrieved item codes;
( c ) in response to a detection of a user's intention of making a reservation, the user terminal sending a reservation request, a selected item code selected by the user and a store code of a store that keeps a stock of said selected item code to the center apparatus;
(d) in response to a reception of said reservation request, the center apparatus generating a unique reservation code for said reservation, sending said reservation code and said selected item code to the store apparatus identified by said store code;
(e) in response to a reception of said reservation code, said store apparatus identified by said store code storing a reservation record including said reservation code, said selected item code and a valid term associated with said selected item code, and sending said valid term to said center apparatus;
(f) in response to a reception of said valid term, the center apparatus sending said reservation code and said valid term to the user terminal; and
(g) in response to an input of a reservation code presented by a customer, said store apparatus deleting said record if said presented reservation code is identical to said reservation code of said stored reservation record and valid considering from said valid term of said stored reservation record.

8. A method as defined in claim 7, further comprising the step of discarding said stored reservation record if said valid term has expired.

9. A method as defined in claim 7, wherein said step (e) includes the step of alerting an attendant if the stock of an item identified by said selected item code is fewer than a preset quantity.

10. A method as defined in claim 7, wherein said step (a) also presents additional store identifiers of additional stores that have no stock of each of said available item, and wherein the method further includes the steps of:
(c′) in response to a detection of a user's intention of making a second-type reservation, the user terminal sending a reservation request, said selected item code and a store code of one of said additional stores selected by the user to the center apparatus;
(d′) in response to a reception of said reservation request and said store code, the center apparatus generating a unique reservation code for said second-type reservation, sending said reservation code, said selected item code and said store code to the store apparatus of a stock-keeping store that keeps a stock of the item identified by said selected item code;
(e′) in response to a reception of said reservation code and said store code, said store apparatus of said stock-keeping store storing a record including said reservation code, said selected item code, said store code and a valid term associated with said selected item code, sending said valid term to said center apparatus, and giving an attendant an instruction to forward at least one item identified by said selected item code to a store identified by said store code.

11. A method as defined in claim 9, further comprising the step of discarding said stored reservation record if said valid term has expired.

12. A method as defined in claim 10, wherein said step (e) includes the step of alerting an attendant if the stock of an item identified by said selected item code is fewer than a preset quantity.

13. A method as defined in claim 7, further comprising the step of at least one of said respective stores deciding to provide benefits to a user who has made a reservation for an item of said at least one of said respective stores and comes to said at least one of said respective stores within a predetermined period of time such that a user who comes earlier after reservation gets more benefit, and wherein said step (b) includes the step of presenting information on said benefits.

14. A method as defined in claim 13, wherein said step (f) also sends said information on said benefits.

15. A method as defined in claim 10, further comprising the steps, executed by said center apparatus, of:
counting a number of reservations for each store; and
charging each store for said number of reservations.

16. A method as defined in claim 10, further comprising the steps, executed by said center apparatus, of:
counting, for each store identified by said store code, a number of forwarding deals received by said each store; and
charging said each store for said number of forwarding deals.

17. A method as defined in claim 7, further comprising the step of said center apparatus collecting said reservation records from all stores, wherein said step (g) comprises the steps of:
in response to an input of a reservation code presented by a customer, said store apparatus sending said presented reservation code to the center apparatus if said presented reservation code is identical to said reservation code of said stored reservation record and valid considering from said valid term of said stored reservation record;
said center apparatus making tests of the validities of the reservation and the term of the reservation and returning the test result to said store apparatus; and
said store apparatus deleting said record if the test result is successful.

18. A method as defined in claim 17, further comprising the step of, if said valid term has expired, said center apparatus discarding said stored reservation record and informing said store apparatus of the expiration of said valid term.

19. A method as defined in claim 10, further comprising the steps, executed by said center apparatus, of:
keeping an item forwarding list arranged according to destination stores identified by said store codes and forwarding dates from the reservation records; and
controlling said store apparatuses to forward the second-type reserved articles from the stock-keeping stores to said destination stores according to said item forwarding list by using any suitable transport means.

20. A method as defined in claim 10, further comprising the steps, executed by said center apparatus, of:
totalizing kinds and numbers of the second-type reserved articles required by each store through collection and analysis of said reservation records; and
instructing said store apparatuses to adjust the kinds and the numbers of the second-type reserved articles among said store apparatuses.

21. A system for permitting a user to input user key words and for providing the user with information on at least one item that match(s) the user key words and, for each provided item, information on at least one store keeping a stock of the provided item, the system comprising:
a plurality of store apparatuses provided in respective stores;
a center apparatus capable of communicating with the store apparatuses; and
a user terminal used by the user and capable of communicating with the center apparatus, the center apparatus comprising:
means for generating a set of unique item codes collected from all stores involved;
means for assigning each item code item key words suitable to an item identified by the item code to generate a set of relations, each relation associating one of said unique item codes with item key words assigned to the unique item code;
means for collecting, from each store apparatus, a list of item codes of items kept in stock by the store having the store apparatus;
means for retrieving item codes from said set of relations by using said user key words;
means for obtaining store codes associated with each of said retrieved item codes by using all of said lists of item codes; and
means for providing the user terminal with at least a pert of said retrieved item codes and further providing, for each of at least a pert of said retrieved item codes, at least a part of said obtained store codes.

22. A system as defined in claim 21, wherein the center apparatus further comprises means for collecting various information associated with each item code and various information associated with each store code from all stores involved and wherein said providing means includes means for providing at least a part of said various information associated with each of said provided item codes and at least a part of said various information associated with each of said provided store codes.

23. A system as defined in claim 21, wherein the center apparatus further comprises means for sending a set of unique item key words to each store apparatus, wherein each store apparatus includes means for assigning similar key words to each item key words in said set to generate a similar key word table, wherein said retrieving means includes:
means, responsive to a determination that there is any user key word that is not found in said item key words, for obtaining substitute item key words associated, by said similar key word table, with said any key word from at least one store apparatus;
means for retrieving additional item codes from said set of relations by using said substitute item key words; and
means for regarding said retrieved item codes and said additional item codes as a retrieval result.

24. A system as defined in claim 22, wherein said various information associated with each item code includes information on a place where the item is displayed.

25. A system as defined in claim 24, wherein said providing step includes displaying a degree of congestion of said place.

26. A system as defined in claim 21, wherein said providing means includes the step of displaying, on the user terminal, a button that enable the user to instruct the system to display similar key words similar to the user key words, and wherein the system further comprises:
means, provided in said center apparatus, for sending a set of unique item key words to each store apparatus;
mean, provided in each store apparatus, for assigning similar key words to each item key words in said set to generate a similar key word table:
means, provided in said center apparatus and responsive to a detection of a predetermined operation of said button by the user, for obtaining said similar key words associated, by said similar key word table, with the user key words from at least one store apparatus;
means, provided in said center apparatus, for retrieving item codes from said set of relations by using said similar key words; and
means, provided in said center apparatus, for causing the user terminal to display at least a part of said similar key words and information on items identified by at least a pert of said retrieved item codes.

27. A system for permitting a user to have a desired item reserved by a store without letting the store know any private information, wherein the desired item may be an article or service, the system comprising:
a plurality of store apparatuses provided in respective stores;
a center apparatus capable of communicating with the store apparatuses; and
a user terminal used by the user and capable of communicating with the center apparatus, the system further comprising:
(a) means, provided in the center apparatus and responsive to a request from the user, for presenting a plurality of item identifiers of items available from said respective stores and a store identifier of a store that keeps a stock of each of said available items;
(b) means, provided in the center apparatus, for prompting the user to make a reservation for one of said retrieved item codes;
(c) means, provided in the user terminal and responsive to a detection of a user's intention of making a reservation, for sending a reservation request, a selected item code selected by the user and a store code of a store that keeps a stock of said selected item code to the center apparatus;
(d) means, provided in the center apparatus and responsive to a reception of said reservation request, for generating a unique reservation code for said reservation, sending said reservation code and said selected item code to the store apparatus identified by said store code;
(e) means, provided in each store apparatus and responsive to a reception of said reservation code, for storing a reservation record including said reservation code, said selected item code and a valid term associated with said selected item code, and sending said valid term to said center apparatus;
(f) means, provided in the center apparatus and responsive to a reception of said valid term, for sending said reservation code and said valid term to the user terminal; and
(g) means, provided in each store apparatus and responsive to an input of a reservation code presented by a customer, for deleting said record if said presented reservation code is identical to said reservation code of said stored reservation record and valid considering from said valid term of said stored reservation record.

28. A system as defined in claim 27, wherein each store apparatus further includes means for discarding said stored reservation record if said valid term has expired.

29. A system as defined in claim 27, wherein said means (e) includes means for alerting an attendant if the stock of an item identified by said selected item code is fewer than a preset quantity.

30. A system as defined in claim 27, wherein said means (a) also presents additional store identifiers of additional stores that have no stock of each of said available item, and wherein the system further includes:
(c′) means, provided in the user terminal and responsive to a detection of a user's intention of making a second-type reservation, for sending a reservation request, said selected item code and a store code of one of said additional stores selected by the user to the center apparatus;
(d′) means, provided in the center apparatus and responsive to a reception of said reservation request and said store code, for generating a unique reservation code for said second-type reservation, sending said reservation code, said selected item code and said store code to the store apparatus of a stock-keeping store that keeps a stock of the item identified by said selected item code;
(e′) means, provided in each store apparatus and responsive to a reception of said reservation code and said store code, for storing a record including said reservation code, said selected item code, said store code and a valid term associated with said selected item code, sending said valid term to said center apparatus, and giving an attendant an instruction to forward at least one item identified by said selected item code to a store identified by said store code.

31. A system as defined in claim 30, wherein each store apparatus includes means for discarding said stored reservation record if said valid term has expired.

32. A system as defined in claim 39, wherein said means (e) includes means for alerting an attendant if the stock of an item identified by said selected item code is fewer than a preset quantity.

33. A system as defined in claim 27, wherein at least one of stores provides benefits to a user who has made a reservation to said at least one of said respective stores and comes to said at least one of said respective stores within a predetermined period of time such that a user who comes earlier after reservation gets more benefit; and wherein said means (b) includes means for presenting information on said benefits.

34. A system as defined in claim 33, wherein said means (f) also sends said information on said benefits.

35. A system as defined in claim 27, wherein the center apparatus further comprises:
means for counting a number of reservations for each store; and
means for charging each store for said number of reservations.

36. A system as defined in claim 30, wherein said center apparatus comprises:
means for counting, for each store identified by said store code, a number of forwarding deals received by said each store; and
means for charging said each store for said number of forwarding deals.

37. A system as defined in claim 27, further comprising means, provided in said center apparatus, for collecting said reservation records from all stores, wherein said means (g) comprises:
means, provided in said store apparatus and responsive to an input of a reservation code presented by a customer, for sending said presented reservation code to the center apparatus if said presented reservation code is identical to said reservation code of said stored reservation record and valid considering from said valid term of said stored reservation record;
means, provided in said center apparatus, for making tests of the validities of the reservation and the term of the reservation and returning the test result to said store apparatus; and
means, provided in said store apparatus, for deleting said record if the test result is successful.

38. A system as defined in claim 37, further comprising means, provided in said center apparatus and responsive to a determination that said valid term has expired, for discarding said stored reservation record and informing said store apparatus of the expiration of said valid term.

39. A system as defined in claim 30, wherein said center apparatus further comprises:
means for keeping an item forwarding list arranged according to destination stores identified by said store codes and forwarding dates from the reservation records; and
means for controlling said store apparatuses to forward the second-type reserved articles from the stock-keeping stores to said destination stores according to said item forwarding list by using any suitable transport means.

40. A system as defined in claim 30, wherein said center apparatus further comprises:
means for totalizing kinds and numbers of the second-type reserved articles required by each store through collection and analysis of said reservation records; and
means for instructing said store apparatuses to adjust the kinds and the numbers of the second-type reserved articles among said store apparatuses.

41. A center apparatus for use in a system for permitting a user to input user key words and for providing the user with information on at least one item that match(s) the user key words and, for each provided item, information on at least one store keeping a stock of the provided item, wherein the system comprising a plurality of store apparatuses provided in respective stores and communicating with the center apparatus and a user terminal used by the user and communicating with the center apparatus, the center apparatus comprising:
means for generating a set of unique item codes collected from all stores involved;
means for assigning each item code item key words suitable to an item identified by the item code to generate a set of relations, each relation associating one of said unique item codes with item key words assigned to the unique item code;
means for collecting, from each store apparatus, a list of item codes of items kept in stock by the store having the store apparatus;
means for retrieving item codes from said set of relations by using said user key words;
means for obtaining store codes associated with each of said retrieved item codes by using all of said lists of item codes; and
means for transmitting, to the user terminal, at least a pert of said retrieved item codes and at least a part of said obtained store codes to cause the user terminal to display information on said transmitted retrieved item codes and, for each of said transmitted retrieved item codes, information on said transmitted obtained store codes.

42. A center apparatus as defined in claim 41, wherein the center apparatus further comprises means for collecting various information associated with each item code and various information associated with each store code from all stores involved and wherein said transmitting means includes means for providing at least a part of said various information associated with each of said provided item codes and at least a part of said various information associated with each of said provided store codes.

43. A center apparatus as defined in claim 41, further comprising means for sending a set of unique item key words to each store apparatus, wherein each store apparatus assigns similar key words to each item key words in said set to generate a similar key word table, wherein said retrieving means includes:
means, responsive to a determination that there is any user key word that is not found in said item key words, for obtaining substitute item key words associated, by said similar key word table, with said any key word from at least one store apparatus;
means for retrieving additional item codes from said set of relations by using said substitute item key words; and
means for regarding said retrieved item codes and said additional item codes as a retrieval result.

44. A center apparatus as defined in claim 42, wherein said various information associated with each item code includes information on a place where the item is displayed.

45. A center apparatus as defined in claim 44, wherein said transmitting means includes means for transmitting a degree of congestion of said place to cause the user terminal to display said degree of congestion of said place.

46. A center apparatus as defined in claim 41, wherein said transmitting means includes means for causing the user terminal to display a button that enable the user to instruct the system to display similar key words similar to the user key words, and wherein the center apparatus further comprises:
means for sending a set of unique item key words to each store apparatus, which assigns similar key words to each item key words in said set to generate a similar key word table;
means, responsive to a detection of a predetermined operation of said button by the user, for obtaining said similar key words associated, by said similar key word table, with the user key words from at least one store apparatus;
means for retrieving item codes from said set of relations by using said similar key words; and
means for causing the user terminal to display at least a part of said similar key words and information on items identified by at least a pert of said retrieved item codes.

47. A center apparatus for use in a purchase support system for permitting a user to have a desired item reserved by a store without letting the store know any private information, wherein the desired item may be an article or service, and wherein the purchase support system comprising a plurality of store apparatuses provided in respective stores and communicating with the center apparatus and a user terminal used by the user and communicating with the center apparatus, the center apparatus comprising:
(a) means responsive to a request from the user, for presenting a plurality of item identifiers of items available from said respective stores and a store identifier of a store that keeps a stock of each of said available items;
(b) means for prompting the user to make a reservation for one of said retrieved item codes;
(c) means, responsive to a reception of a reservation request, a selected item code selected by the user and a store code of a store that keeps a stock of said selected item code which are transmitted by the user terminal in response to a detection of a user's intention of making a reservation, for generating a unique reservation code for said reservation, sending said reservation code and said selected item code to the store apparatus identified by said store code, which store apparatus responsively stores a reservation record that includes the received information and a valid term associated with the reservation code; and
(d) means, responsive to a reception of said valid term for the reservation identified by said reservation code, for sending said reservation code and said valid term to the user terminal.

48. A center apparatus as defined in claim 47, further comprising:
means for collecting said reservation records from all stores;
means, responsive to a reception of a presented reservation code which is presented by a customer and transmitted from one of said store apparatuses, for making tests of the validities of the reservation and the term of the reservation and returning the test result to said store apparatus; and
means for deleting a record associated with said presented reservation code if the test result is successful.

49. A center apparatus as defined in claim 48, farther comprising:
means for discarding said stored reservation record if said valid term has expired and inform one of store apparatuses associated with said stored reservation record of the expiration of said valid term.

50. A center apparatus as defined in claim 27, wherein said means (a) also presents additional store identifiers of additional stores that have no stock of each of said available item, and wherein the center apparatus further includes; and
(b′) means, responsive to a reception of said reservation request, said store code and a store code of one of said additional stores selected by the user which are transmitted from the user terminal in response to a detection of a user's intention of making a second-type reservation, for generating a unique reservation code for said second-type reservation, sending said reservation code, said selected item code and said store code to the store apparatus of a stock-keeping store that keeps a stock of the item identified by said selected item code, wherein said store apparatus stores a reservation record that includes the received information and a valid term associated with said reservation code.

51. A center apparatus as defined in claim 50, further comprising:
means for collecting said reservation records from all stores;
means, responsive to a reception of a presented reservation code which is presented by a customer and transmitted from one of said store apparatuses, for making tests of the validities of the reservation and the term of the reservation and returning the test result to said store apparatus; and
means for deleting a record associated with said presented reservation code if the test result is successful.

52. A center apparatus as defined in claim 51, further comprising:
means for discarding said stored reservation record if said valid term has expired.

53. A center apparatus as defined in claim 47, wherein at least one of stores provides benefits to a user who has made a reservation to said at least one of said respective stores and comes to said at least one of said respective stores within a predetermined period of time such that a user who comes earlier after reservation gets more benefit, and wherein said means (d) also sends information on said benefits.

54. A center apparatus as defined in claim 47, further comprising:
means for counting a number of reservations for each store; and
means for charging each store for said number of reservations.

55. A center apparatus as defined in claim 50, further comprising:
means for counting, for each store identified by said store code, a number of forwarding deals received by said each store; and
means for charging said each store for said number of forwarding deals.

56. A center apparatus as defined in claim 50, further comprising:
means for keeping an item forwarding list arrange d according to destination stores identified by said store codes and forwarding dates from the reservation records; and
means for controlling said store apparatuses to forward the second-type reserved articles from the stock-keeping stores to said destination stores according to said item forwarding list by using any suitable transport means.

57. A center apparatus as defined in claim 50, further comprising:
means for totalizing kinds and numbers of the second-type reserved articles required by each store through collection and analysis of said reservation records; and
means for instructing said store apparatuses to adjust the kinds and the numbers of the second-type reserved articles among said store apparatuses.
